(19) United States
(12) Patent Application Publication
(10) Pub. No.: US 2015/0248441 A1
(43) Pub. Date: Sep. 3, 2015

(54) TIME-SERIES DATA PROCESSING DEVICE, TIME-SERIES DATA PROCESSING METHOD AND MEDIUM FOR STORING TIME-SERIES DATA PROCESSING PROGRAM

(71) Applicant: NEC CORPORATION, Minato-ku, Tokyo (JP)

(72) Inventor: Masamichi Takagi, Tokyo (JP)

(21) Appl. No.: 14/427,236

(22) PCT Filed: Sep. 13, 2013
(86) PCT No.: PCT/JP2013/005439

§ 371 Date: Mar. 10, 2015

(30) Foreign Application Priority Data
Sep. 18, 2012 (JP) 2012-204425

(51) Int. Cl. G06F 17/30

(52) U.S. Cl. CPC G06F 17/30309

(57) ABSTRACT

Provided is a time-series data device that, at a time of process switching, can output results obtained by an old process at around the process switching to the outside, without outputting to the outside both of results by the old process and by a new process in a mixed manner, and also can reduce the amount of additional information and a delay due to an additional process, which are required for realizing the characteristics.

The time-series data device comprises: a first processing means that performs a first process and thereby outputs a first resultant datum; a second processing means that performs a second process and thereby outputs a second resultant datum; a control means that, when having received instructions for process switching, determines whether or not the first process can be stopped, and generates a first and a second resultant data sets by adding first and second identification information, each representing the state of a corresponding process, to respectively the first and second resultant data; and a selection means that stores third identification information designating a resultant datum to be outputted to the outside and, when the first or second resultant data set has arrived at it, selects and outputs either of the first and second resultant data sets and discards the other, on the basis of a result of comparison between the first, second, and third identification information.

### TECHNICAL FIELD

The present invention relates to a time-series data processing device, a time-series data processing method and a time-series data processing program, each of which performs processing of time-series data. In particular, the present invention relates to a time-series data processing device, a time-series data processing method and a time-series data processing program, where the content of a process to be performed on time-series data is switched.

### BACKGROUND ART

First, “data processing on time-series data” will be described. In the present DESCRIPTION, “data processing on time-series data” is referred to as processing which is performed on time-series input data, that is, a series of data inputted one after another. Resultant data obtained by the data processing on time-series data also are outputted one after another similarly. “Inputted one after another” means that a plurality of data arrive at a processing device at respectively different time points over a certain time period. As an example of data processing on time-series data, mentioned is processing which takes the sum of the most recent two values out of time-series data. Hereafter, data processing on time-series data is referred to simply as “time-series data processing”.

In the following descriptions, an array of data is expressed as such as [1, 2, 3, 4], a group of data as such as {1, 2, 3, 4}, and a set of data as such as <10 degrees, January 1>, thus distinguishing them from each other by the use of the different types of parentheses. Values of individual data such as 1 and 2 are expressed as such as “1” and “2”, and are thereby distinguished from signs for representing constituent elements.

The period of a clock used for operation of a time-series data processing device is referred to as a “cycle”, which is then used as the unit of time period. “Start time of a cycle” means the first time point of the time period, and “end time of a cycle” does the last time point of the time period. For example, when the clock frequency is 1 GHz, with respect to a certain reference time, the first cycle means the time period from “the reference time plus zero second” to “the reference time plus 1 nanosecond”, and the N-th cycle means that from “the reference time plus (N−1) nanoseconds” to “the reference time plus N nanoseconds”. The start time of the M-th cycle means “the reference time plus (M−1) nanoseconds”, and the end time of the M-th cycle means “the reference time plus M nanoseconds”.

Here, each of input data is a set consisting of one or more values.

As examples of an input datum, mentioned are a set of a temperature value and a date, a set of only temperature values and a set of a brand, a stock price and a time. For example, a set of a temperature value and a date is expressed as such as <10 degrees, January 1>. If there is no possibility of confusing such input data with values processed in a time-series data processing device, the input data are referred to simply as “data”.

In many cases, time-series data processing is performed on a plurality of input data. Further, time-series data processing is often performed on a window of time-series data. The “window” is a group of input data, and there are two types of windows. One is a group of the most recent N-number of input data, where N is a predetermined number (an integer equal to or larger than 1). The other is a group of input data included in a predetermined time period P, where one of the elements of each datum is regarded as a time.

For example, it is assumed that an input datum is defined to be a set of a temperature value and a date, and time-series data <10 degrees, January 1>, <11 degrees, January 2>, <10 degrees, January 3> and <10 degrees, January 4> are given. A window included in the time period consisting of January 4 and the previous two days is {<11 degrees, January 2>, <10 degrees, January 3>, <10 degrees, January 4>}.

Further, a group of, a partial group of and elements of input data included in a window are each referred to as a “window datum”. In many cases of time-series data processing, such window data are stored. In the following descriptions, a window or a window datum is expressed in the form of an array or a group.

It is assumed that time-series data processing is performed by the use of an IC (Integrated Circuit) chip which has a plurality of areas (hereafter, referred to as “partitions”) each capable of defining the content of a process, which are specifically a plurality of areas into each of which circuit information or the like for configuring a circuit to perform the process can be written. As an example of such an IC chip, an FPGA (Field Programmable Gate Array) is mentioned. Alternatively, time-series data processing may be performed by the use of, as such an IC chip, a processor which reads a program from a memory and then executes the program. In that case, it is only necessary to write a program specifying the content of a process, that is, a procedure of the process into the memory.

There are needs, in time-series data processing, where it is desired to switch from a first user-defined process (referred to as an “old process”) to a second user-defined process (referred to as a “new process”). That is, a first user-defined process (referred to as an “old process”) is performed in a first partition in an IC chip. Then, at a time of performing the first user-defined process, circuit information for performing a second user-defined process (referred to as a “new process”) is written into a second partition, and then the new process is performed, and the old process is subsequently stopped. There are needs where it is desired to switch from an old process to a new process in that way.

As an example, considered is an application for detecting an emergency including a fire by using, as input data, values of temperature sensors dispersively arranged over a wide range and taking their averages over a certain time period. There are needs of reducing, when temperature variation has become rapid, the duration of a time period over which an average of temperatures is taken, so as to increase the speed of following the temperature variation.

As another example, considered is an application for calculating an indicator for determining a timing of trading a financial product such as a stock. There are a plurality of necessary indicators, and a set of indicators to be outputted varies, depending on brands of financial products to be traded and a trade strategy. One device can calculate only a finite number of indicators simultaneously. A brand to be traded and the trade strategy change with time. Therefore, there are needs where it is desired to change indicators to be calculated in accordance with a brand to be traded and the trade strategy at that time.

Using FIG. 17, an example of process switching in a background art technology will be described. In the present case, process switching is made from an old process of taking the sum of the most recent two values to a new process of taking the sum of the most recent three values.

Assuming that a datum is inputted at each cycle, the following description will be given using a time scale whose unit is equal to one cycle.

At the start time of the first cycle, a time-series datum “1” is inputted, and the old process stores the value as a window datum.

At the start time of the second cycle, a time-series datum “2” is inputted, and the old process stores the value as a window datum. Thus having obtained the most recent two values, the old process outputs “3” as a resultant datum.

At the start time of the third cycle, instructions for switching to the new process are given. It is assumed that, also at that time, information for performing the new process is written into the device, and the new process is started to operate. For example, it is assumed that circuit information for performing the new process is written into a partial area of an FPGA. Here, it is assumed that the circuit information for performing the new process is written separately from that for performing the old process, and the old and new processes are operated in parallel for a while.

At the start time of the third cycle, a time-series datum “3” is inputted, and the new process stores the value as a window datum.

At the start time of the fourth cycle, a time-series datum “4” is inputted, and the new process stores the value as a window datum.

At the start time of the fifth cycle, a time-series datum “5” is inputted, and the new process stores the value as a window datum. Thus having obtained the most recent three values, the new process outputs “12” as a resultant datum.

At that time, the old process is stopped or eliminated, and the process switching is thereby completed.

In the above-described case, there are needs where it is desired, at the time of process switching, (1) to perform both of the new and old processes while avoiding that both of a result by the new process and that by the old process are outputted in a mixed manner to the outside of the device, and (2) to perform both of the new and old processes while outputting some results by the old process, which are still useful and usable ones among those obtained by the old process at around the process switching, to the outside of the device.

As an example, considered is the above-mentioned application for detecting an emergency including a fire by taking an average of values of temperature sensors over a certain period of time. In that case, it is desirable, when temperature variation has become rapid, to change the duration of a time period over which an average of temperatures is taken, so as to increase the speed of following the temperature variation. It is also required to change the process in a manner of not outputting both of a result by the new process and that by the old process in a mixed manner, so as to avoid causing confusion between the results by the old and new processes. Further, it is desirable to receive as many results by the old process as possible from the device until outputting of a result by the new process to the outside of the device is started, because even results by the old process are still useful and usable. There are such needs in this example.

As another example, considered is the application for instructing a trade of a financial product such as a stock. In that case, it is required to change a process for instructing a trade because of willing to change a brand to be traded. A brand before the change is referred to as an “old brand”, and that after the change as a “new brand”. If an instruction relating to the new brand and that relating to the old brand both exist in a mixed manner at around the time of process switching, there is a possibility of misconducting a trade. Therefore, the process switching needs to be performed such that not both of a result by the new process and that by the old process are outputted in a mixed manner to the outside of the device. It is also desirable to receive as many results by the old process as possible from the device until outputting of a result by the new process to the outside of the device is started, because a trade instruction with respect to the old brand might be made until the very last timing. There are such needs in this example.

Furthermore, in this application, there are needs where it is desired to stop the old process after a safety state is established during the process switching. For example, there is a case where it is desired that, after issuing a selling instruction, the old process is kept enabled to output an instruction until a buying instruction is issued, and then after the issuing of the buying instruction, only the new process is enabled to output an instruction. That is, there are needs of (1) enabling an array of results outputted from the old process having not become in a stoppable state to be outputted to the outside of the device, because the array is useful and usable, and (2) subsequently enabling an array of results outputted from the new process to be outputted to the outside of the device, in place of an array of results outputted from the old process having become in a stoppable state.

Technologies related to the above-described processes are described in Patent Literature 1 to Patent Literature 4 and Non-patent Literature 1.

Patent Literature 1 (PTL 1) discloses a system using a reconfigurable device.

Patent Literature 2 (PTL 2) discloses a time-series data compression device which performs two kinds of processing.

Patent Literature 3 and Patent Literature 4 (PTL 3 and PTL 4) disclose processing devices which deal with information to which a version number (an update version number) is added.

One of functions necessary for process update is identifying which one between a result by an old process and that by a new process a processing result is. It is possible, by combining the technologies of PTL 2 to PTL 4 together, to perform two kinds of processes, an old and a new processes, on time-series data and distinguish a result by the old process and that by the new process from each other.

A detailed description will be given below of a method of distinguishing between a result by an old process and that by a new process, which is achieved by combining PTL 2 to PTL 4 together. In FIG. 29, shown is a block diagram showing a configuration of a time-series data processing device which is configured by combining the technologies of PTL 2, PTL 3 and PTL 4 together. The time-series data processing device in FIG. 29 comprises processing units 601 and a version comparison unit 611.

The processing units 601 each perform a user-defined process corresponding to an old process or a user-defined process corresponding to a new process, and output a result of the process after adding it a process number and a version number which enable identifying the process.

The version comparison unit 611 records the latest version number for each process. On receiving a resultant datum, the version comparison unit 611 distinguishes between a result by the old process and that by the new process by comparing the stored latest version number for the process with the version number added to the received resultant datum. Then, according to the result of the distinguishing, the version comparison unit 611 discards a result by the old process and output a result by the new process to the outside.

Using FIG. 30, operation of the time-series data processing device in FIG. 29 will be described below. From a processing unit having performed an old process to the version comparison unit 611, outputted are a datum “1” resulting from the process, a process number “32767”, which is the number common to the old process and a corresponding new process and enabling distinguishing a result by the old or new processes from results by other processes, and a version number (update version number) of the process “65534”. These output data are expressed in a format of <result, process number, version number>.

From a processing unit having performed the new process to the version comparison unit 611, outputted are a datum “2” resulting from the process, the above-described process number “32767” and a version number (update version number) of the process “65535”.

From a processing unit having performed another process relating to neither of the new and old processes to the version comparison unit 611, outputted are a datum “3” resulting from the process, a process number “32768”, which is the number assigned to only the process, and a version number (update version number) of the process “65535”.

Using the process number added to a resultant datum, the version comparison unit 611 extracts the latest version number corresponding to the process number from a table storing the latest version numbers. It then compares the latest version number with the version number added to the resultant datum. The version comparison unit 611 determines that the resultant datum is a result obtained by the old process if the version number of the resultant datum is older, and that the resultant datum is a result by the new process if the version number of the resultant datum is not older. By that process, distinguishing between a result by the old process and that by the new process is performed. It thereby becomes possible to discard a result by the old process and output a result by the new process, according to a result of the distinguishing.

Non-patent Literature 1 (NPL 1) discloses a time-series data processing device which can perform two kinds of processes, an old process and a new process. While implementation by software is assumed in NPL 1, implementation by hardware is assumed here for convenience, and a configuration diagram in such a case is shown in FIG. 18.

The technology of NPL 1 comprises processing units 501 each of which performs a user-defined process corresponding to an old process or a user-defined process corresponding to a new process, and a merging unit 511 which leads results by the processing units to an output port to the outside.

In the technology of NPL 1, operation is performed in methods roughly classified into two types of methods. Operation in the first method will be described below using FIGS. 19 to 23.

In the present example, process switching is made from an old process of taking the sum of the most recent two values to a new process of taking the sum of the most recent three values. It is assumed that both of the old and new processes generate a result within the same cycle in which the most recent datum is inputted. It is also assumed that processing results outputted from the processing units 501 arrive at the merging unit 511 in one cycle. It is also assumed that a processing result outputted from the merging unit 511 arrives at the outside of the device in one cycle. It is further assumed that a datum is inputted in each cycle, and the following description will be given using a time scale whose unit is one cycle.

It is assumed that a time-series datum “1” is inputted at the start time of the first cycle, and a time-series datum “2” at the start time of the second cycle. The old process thus having obtained the most recent two values [1, 2], a corresponding processing unit 501 calculates and outputs a result “3”. At the end time of the second cycle, the units become in the respective states shown in FIG. 19.

It is assumed that, at the start time of the third cycle, the content of a new process is defined, and performing the new process is started. The definition of a new process is performed, for example, when the device realizing the processing is an FPGA, by the use of the partial reconfiguration function of the FPGA. It is then assumed that a time-series datum “3” is inputted to both of the old and new processes. The old process outputs a result “5”. The new process holds the time-series datum “3”. The result “3” previously outputted by the old process is outputted to the outside of the device. At the end time of the third cycle, the units become in the respective states shown in FIG. 20.

It is assumed that, at the start time of the fourth cycle, a time-series datum “4” is inputted to both of the old and new processes. The old process outputs a result “7”. The new process holds the time-series datum “4”. The result “5” previously outputted by the old process is outputted to the outside of the device. At the end time of the fourth cycle, the units become in the respective states shown in FIG. 21.

It is assumed that, at the start time of the fifth cycle, a time-series datum “5” is inputted to both of the old and new processes. The old process outputs a result “9”. As it has obtained the most recent three values [3, 4, 5], the new process outputs a result “12”, which is the sum of the three values. The result “7” previously outputted by the old process is outputted to the outside of the device. At the end time of the fifth cycle, the units become in the respective states shown in FIG. 22.

It is assumed that, at the start time of the sixth cycle, a time-series datum “6” is inputted to both of the old and new processes. The old process outputs a result “11”. The new process outputs a result “15”. The results “9” and “12” previously outputted by, respectively, the old and new processes are outputted to the outside of the device. At the end time of the sixth cycle, the units become in the respective states shown in FIG. 23. As has been described above, in the first method of NPL 1, results by the old process and by the new process are outputted to the outside of the device in a mixed manner.

Next, operation by the second method of NPL 1 will be described using FIGS. 24 to 28.

Also in this case, process switching is made from an old process of taking the sum of the most recent two values to a new process of taking the sum of the most recent three values. It is assumed that both of the old and new processes generate a result within the same cycle in which the most recent datum is inputted. It is also assumed that processing results outputted from the processing units arrive at the merging unit in one cycle.

It is also assumed that a processing result outputted from the merging unit arrives at the outside of the device in one cycle. It is further assumed that a datum is inputted in each cycle, and the following description will be given using a time scale whose unit is one cycle.

It is assumed that a time-series datum “1” is inputted at the start time of the first cycle. It is also assumed that a time-series datum “2” is inputted at the start time of the second cycle. The old process thus having obtained the most recent two values [1, 2], a corresponding processing unit 501 calculates and outputs a result “3”. At the end time of the second cycle, the units become in the respective states shown in FIG. 24.

It is assumed that, at the start time of the third cycle, information for performing a new process is written, and performing the new process is started. In the second method, the old process is stopped at that time. It is then assumed that a time-series datum “3” is inputted to both of the old and new processes. The new process holds the time-series datum “3”. At the end time of the third cycle, the units become in the respective states shown in FIG. 25.

It is assumed that, at the start time of the fourth cycle, a time-series datum “4” is inputted to both of the old and new processes. The new process holds the time-series datum “4”. At the end time of the fourth cycle, the units become in the respective states shown in FIG. 26. Thus, in the second method, no result is outputted to the outside of the device at this timing. In contrast, in the first method, a result is outputted as shown in FIG. 21,

It is assumed that, at the start time of the fifth cycle, a time-series datum “5” is inputted to both of the old and new processes. As it has obtained the most recent three values [3, 4, 5], the new process outputs a result “12”. At the end time of the fifth cycle, the units become in the respective states shown in FIG. 27. Thus, in the second method, no result is outputted to the outside of the device even at this timing. In contrast, in the first method, a result is outputted as shown in FIG. 22,

It is assumed that, at the start time of the sixth cycle, a time-series datum “6” is inputted to both of the old and new processes. The new process outputs a result “15”. At the end time of the sixth cycle, the units become in the respective states shown in FIG. 28.

As has been described above, in the second method of NPL 1, it never occurs that results by the old process and by the new process are outputted to the outside of the device in a mixed manner.

### CITATION LIST

### Patent Literature

[PTL 1]
Japanese translation of PCT application No. 2004-508617

[PTL 2]
Japanese Patent Application Laid-Open No. 2001-049747

[PTL 3]
Japanese Patent Application Laid-Open No. 2001-075908

[PTL 4]
Japanese Patent Application Laid-Open No. 2005-049102

### Non Patent Literature

[NPL 1]
Kyumars Sheykh Esmail et al., Changing Flights in Mid-air: A model for Safely Modifying Continuous Queries, In Proc. of SIGMOD '11, June 2011.

### SUMMARY OF INVENTION

### Technical Problem

PTL 1 discloses a system using a reconfigurable device. However, in PTL 1, no reference is made to a problem occurring at a time of rewriting a device configuration file (circuit information for configuring a predetermined circuit). Accordingly, PTL 1 cannot solve such a problem.

PTL 2 discloses a time-series data compression device which performs two kinds of processes. However, in the device of PTL 2, one of the two kinds of processes is adopted on the basis of predetermined determination on a result of a prior process. Then, it is not distinguished which one of the two kinds of processes was adopted to give a final processing result. Accordingly, it is impossible to distinguish between a result by one of the two kinds of processes and that by the other one.

PTL 3 and PTL 4 each disclose a processing device which deals with information to which a version number (update version number) is added. However, in both PTL 3 and PTL 4, the version number is used for identifying whether the information accompanied by the version number is old or new and then updating to new information. Accordingly, information with an older version number is discarded, and therefore, the information cannot be utilized even if it is useful.

Combining the technology of PTL 2 with that of PTL 3 or PTL 4, it becomes possible to perform two kinds of processes, an old and a new processes, on time-series data and distinguish which one of the two kinds of processes was adopted to give a resultant datum. However, the distinguishing is that of only distinguishing whether the adopted process is the old one or the new one, and accordingly, resultant data by the old process cannot be utilized.

As described above, one of functions required for process update is distinguishing between a result by an old process and that by a new process from among a plurality of results obtained by a plurality of processes operated in parallel in a single device. Combining PTL 2 to PTL 4 together, a function to distinguish between a result by the old process and that by the new process can be realized. However, in order to realize the function, it is necessary to store version numbers in a manner to correlate them with process numbers. Accordingly, when the number of kinds of processes is large, a problem occurs in that the data size of additional information necessary to be stored becomes large. Further, because such a process using additional information as described above includes a process of searching for and comparing a version number by the use of a process number, there is also a problem of a large process delay.

A detailed description will be given below of the reason why the above-described two problems occur, using a specific example. As described above, in the technology obtained by combining PTL 2 to PTL 4 together, distinguishing between a result by the old process and that by the new process is performed by adding to each of the results a process number enabling identification of individual results by the old and new processes and a version number of the corresponding process, as shown in FIG. 29. The technology accordingly has a problem in that, when the number of processes simultaneously operated in the device is large, or the range of version numbers is large, the process numbers and the process version numbers require a large data amount.

There is also a problem in that, in a case of enabling distinguishing between the old and new processes by the use of these kinds of information, when the number of processes simultaneously operated in the device is large, or the range of version numbers is large, a delay due to a process for the distinguishing is large.

For example, when 65,536 (=2̂16) kinds of processes are operated in a single device and each of the processes has 65,536 kinds of versions, 16-bit information is required for each of the set of process numbers and that of version numbers. Accordingly, totally 32 bits of information need to be added to a result by the old or new processes. There accordingly is a problem in that it is necessary to store information whose amount is as huge as totally 2,097,152 (=65,536×32) bits, for distinguishing between the old and new processes.

Additionally, there is a problem in that, because a table stored in the version comparison unit needs to record a 16-bit version number for each of the 65,536 kinds of processes, it is necessary to store information whose amount is as huge as totally 1,048,576 (=65,536×16) bits.

Further, the version comparison unit performs comparison between two 16-bit version numbers. Because the comparison process becomes calculation using 32-bit data, there is a problem of a large delay time until a result of the process being revealed.

In the first method of NPL 1, as shown in FIG. 23, both of a result by the old process and that by the new process are outputted to the outside of the device in a mixed manner. It is impossible to distinguish whether a resultant datum outputted in such a mixed manner is obtained by the old process or the new process. Accordingly, there is a problem in that resultant data obtained by the old process at around process switching cannot be utilized.

In the second method of PTL 1, it never occurs that both of a result by the old process and that by the new process are outputted to the outside of the device in a mixed manner. Accordingly, use of resultant datum is possible.

However, even when there is some resultant datum by the old process which is useful and usable, the datum is not outputted to the outside of the device. That is, because the old process has been stopped, while it can be operated, no resultant data which might be obtained by the old process can be outputted to the outside. For example, in the corresponding example described above, the sum of [2, 3] and that of [3, 4] are not outputted, while they are usable.

Even if the old process is kept in operation, a result by the old process and that by the new process are mixed with each other at the merging unit, and accordingly, it is impossible to keep outputting results by the old process until a designated time. In the above-mentioned example, it is impossible to output the sum of [2, 3] and that of [3, 4] in a manner where they are not mixed with results by the new process.

Thus, the second method of NPL 1 has a problem from the viewpoint of effective use of a processing device, where the new process is to be performed to the utmost and its processing result is to be utilized to the utmost.

Summarizing the above descriptions, the technology of NPL 1 outputs a resultant datum by an old process and that by a new process in a mixed manner, without distinguishing between them. As a result, the technology of NPL 1 has a problem in that, at a time of process switching from the old process to the new process at run-time, both a result by the old process and that by the new process are outputted to the outside of the device in a mixed manner.

Further, the technology of NPL 1 stops the old process when it starts the new process. As a result, it has also a problem in that a useful and usable result by the old process is not outputted to the outside of the device.

(Objective of Invention)

The present invention has been achieved in view of the circumstances described above, and accordingly, its objective is to provide a time-series data processing device, a time-series data processing method and a recording medium for storing a data processing program, all of which can, at a time of process switching from a first process to a second process, output to the outside also results obtained by the old process at around the process switching, avoiding outputting both of a result by the old process and that by the new process in a mixed manner, can reduce the amount of additional information for distinguishing between a result by the old process and that by the new process, and further can reduce a time necessary for distinguishing between a result by the old process and that by the new process and for determination in selecting a result to be outputted and a result to be discarded.

### Solution to Problem

A time-series data processing device of the present invention is characterized by that it comprises: a first processing means for performing a first process and thereby outputting a first resultant datum; a second processing means for performing a second process and thereby outputting a second resultant datum; a control means for, when having received instructions for process switching, determining whether or not the first process can be stopped, generating a first set of resultant data by adding to the first resultant datum first identification information representing the state of the first process, and generating a second set of resultant data by adding to the second resultant datum second identification information representing the state of the second process; and a selection means for storing third identification information designating a resultant datum to be outputted to the outside, and for, when having received the first set of resultant data or the second set of resultant data, selecting either the first set of resultant data or the second set of resultant data to output the selected one and discard the other one, on the basis of a result of comparison between the first identification information and the third identification information and of a result of comparison between the second identification information and the third identification information.

A time-series data processing method of the present invention is characterized by that it comprises: performing a first process by a first processing means and thereby outputting a first resultant datum; performing a second process by a second processing means and thereby outputting a second resultant datum; when having received instructions for process switching, determining whether or not the first process can be stopped, generating a first set of resultant data by adding to the first resultant datum first identification information representing the state of the first process, and generating a second set of resultant data by adding to the second resultant datum second identification information representing the state of the second process; and storing third identification information designating a resultant datum to be outputted to the outside, and when having received the first set of resultant data or the second set of resultant data, selecting either the first set of resultant data or the second set of resultant data to output the selected one and discard the other one, on the basis of a result of comparison between the first identification information and the third identification information and of a result of comparison between the second identification information and the third identification information

A recording medium for storing a time-series data processing program of the present invention is characterized by that it stores a program for causing a computer, which is comprised in a time-series data processing device comprising a first processing means for performing a first process and thereby outputting a first resultant datum and a second processing means for performing a second process and thereby outputting a second resultant datum, to function as:

a control means for, when having received instructions for process switching, determining whether or not the first process can be stopped, generating a first set of resultant data by adding to the first resultant datum first identification information representing the state of the first process, and generating a second set of resultant data by adding to the second resultant datum second identification information representing the state of the second process; and a selection means for storing third identification information designating a resultant datum to be outputted to the outside, and for, when having received the first set of resultant data or the second set of resultant data, selecting either the first set of resultant data or the second set of resultant data to output the selected one and discard the other one, on the basis of a result of comparison between the first identification information and the third identification information and of a result of comparison between the second identification information and the third identification information

### Advantageous Effect of Invention

According to the present invention, in time-series data processing, even at a time of switching a process to be performed from a first process to a second process, it never occurs that both of a result by the first process and that by the second process are outputted in a mixed manner to the outside of the device. Further, results obtained by the old process at around the process switching can be outputted to the outside. Furthermore, it is possible to reduce the amount of additional information to be added to resultant data by the old and new processes, and to reduce a time necessary for distinguishing between a result by the old process and that by the new process and for determination in selecting a result to be outputted and a result to be discarded.

### BRIEF DESCRIPTION OF DRAWINGS

FIG. 1 a block diagram showing a configuration of a time-series data processing device in an exemplary embodiment of the present invention.

FIG. 2 a block diagram showing an example of an internal configuration of a selection unit 121.

FIG. 3 a diagram showing an example of a data structure of a set of resultant data.

FIG. 4 a flow chart showing an example of a process performed by the time-series data processing device of the exemplary embodiment of the present invention.

FIG. 5 a flow chart showing an example of a process performed by the time-series data processing device of the exemplary embodiment of the present invention.

FIG. 6 a flow chart showing an example of a process performed by the time-series data processing device of the exemplary embodiment of the present invention.

FIG. 7 a table showing identification information and an output datum in each state of the time-series data processing device of the exemplary embodiment of the present invention.

FIG. 8 a diagram showing a state of output data from respective units, at the end time of the fourth cycle, in a specific example of operation of the exemplary embodiment of the present invention.

FIG. 9 a diagram showing a state of output data from respective units, at the end time of the fifth cycle, in the specific example of operation of the exemplary embodiment of the present invention.

FIG. 10 a diagram showing a state of output data from respective units, at the end time of the sixth cycle, in the specific example of operation of the exemplary embodiment of the present invention.

FIG. 11 a diagram showing a state of output data from respective units, at the end time of the seventh cycle, in the specific example of operation of the exemplary embodiment of the present invention.

FIG. 12 a diagram showing a state of output data from respective units, at the end time of the eighth cycle, in the specific example of operation of the exemplary embodiment of the present invention.

FIG. 13 a diagram showing a state of output data from respective units, at the end time of the ninth cycle, in the specific example of operation of the exemplary embodiment of the present invention.

FIG. 14 a diagram showing a state of output data from respective units, at the end time of the tenth cycle, in the specific example of operation of the exemplary embodiment of the present invention.

FIG. 15 a diagram showing a state of output data from respective units, at the end time of the eleventh cycle, in the specific example of operation of the exemplary embodiment of the present invention.

FIG. 16 a diagram showing a state of output data from respective units, at the end time of the twelfth cycle, in the specific example of operation of the exemplary embodiment of the present invention.

FIG. 17 a temporal transition diagram for states of an old process and a new process in an example of operation of a background art technology.

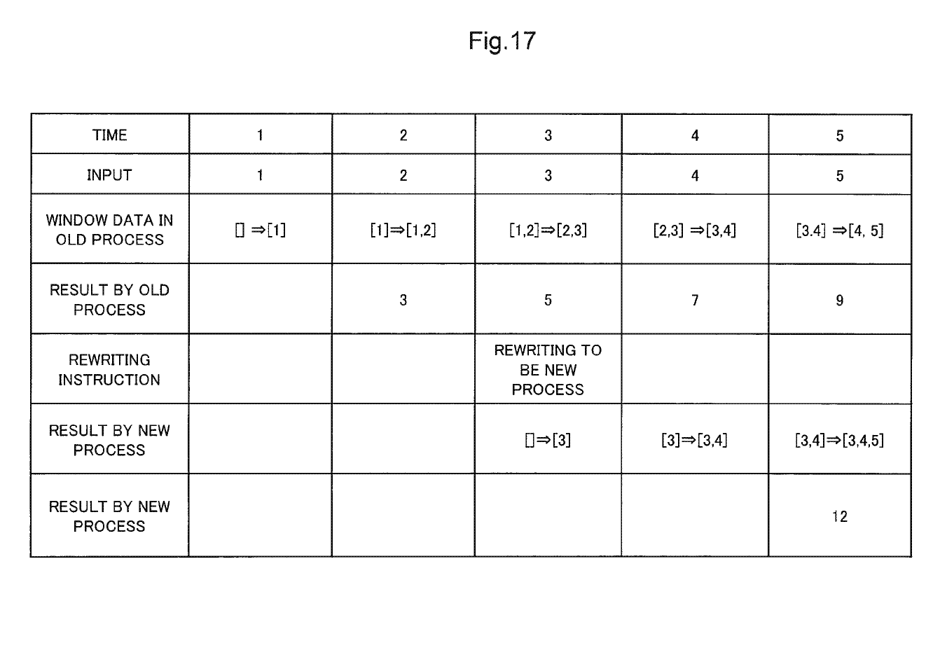

FIG. 18 a block diagram showing a configuration of a time-series data processing device of Non-patent Literature 1 (NPL 1).

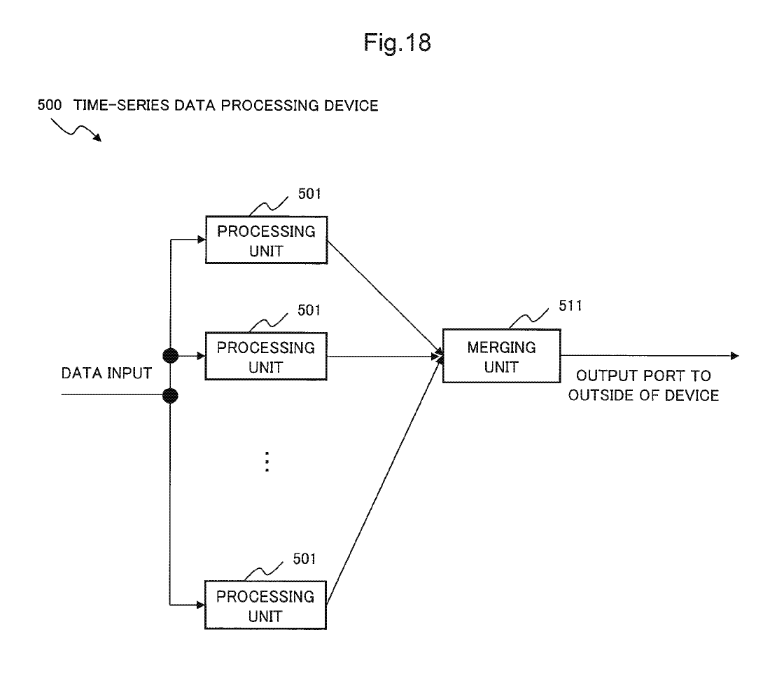

FIG. 19 a diagram showing a state of output data from respective units, at the end time of the second cycle, in a first way of the time-series data processing device of NPL 1.

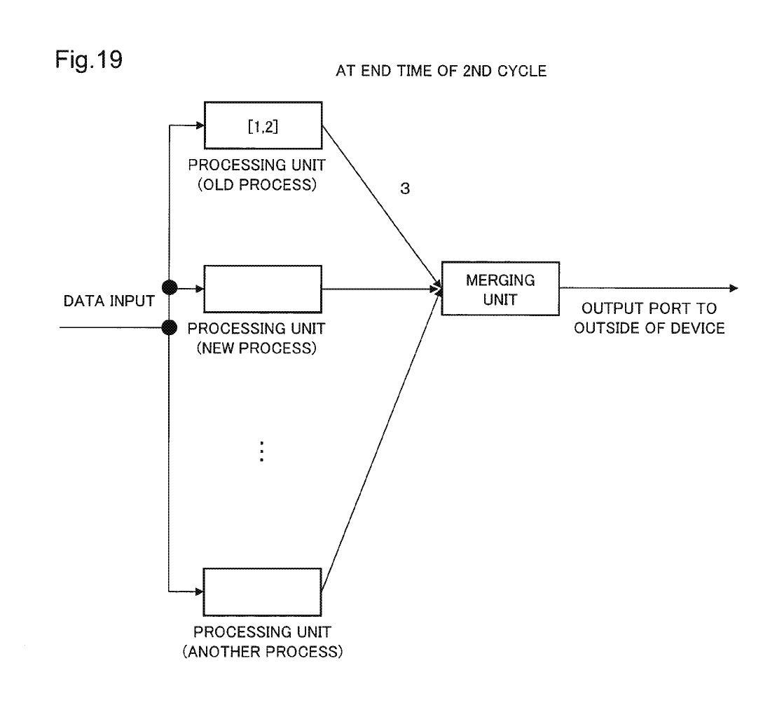

FIG. 20 a diagram showing a state of output data from respective units, at the end time of the third cycle, in the first way of the time-series data processing device of NPL 1.

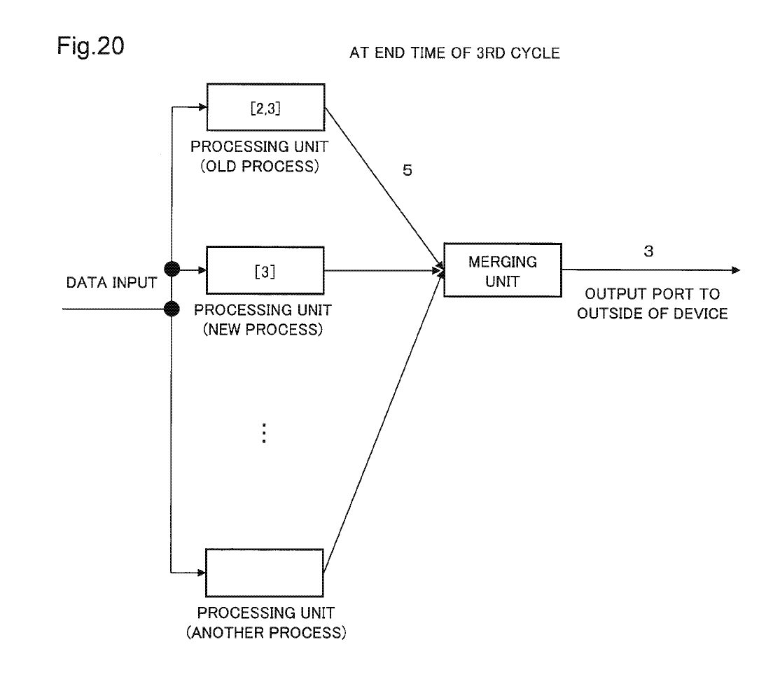

FIG. 21 a diagram showing a state of output data from respective units, at the end time of the fourth cycle, in the first way of the time-series data processing device of NPL 1.

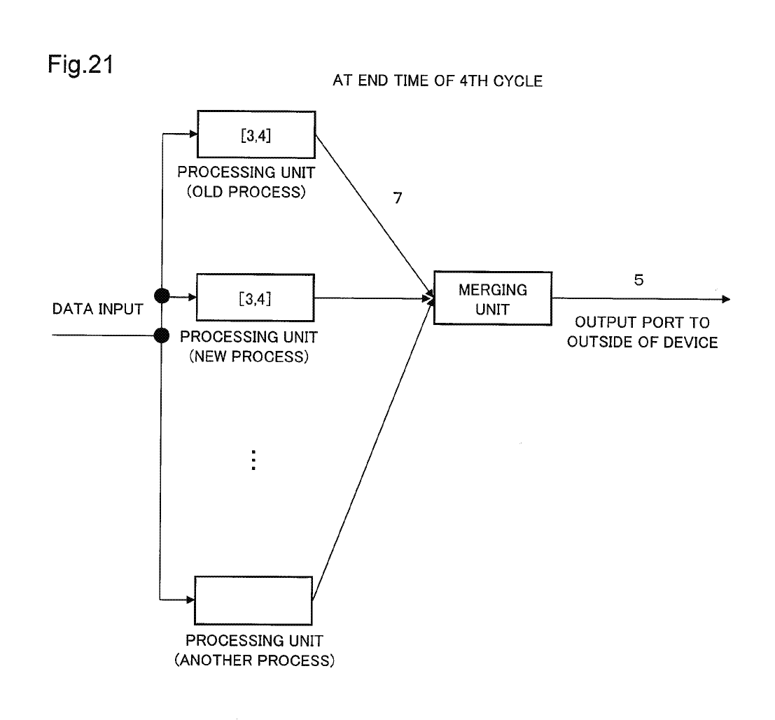

FIG. 22 a diagram showing a state of output data from respective units, at the end time of the fifth cycle, in the first way of the time-series data processing device of NPL 1.

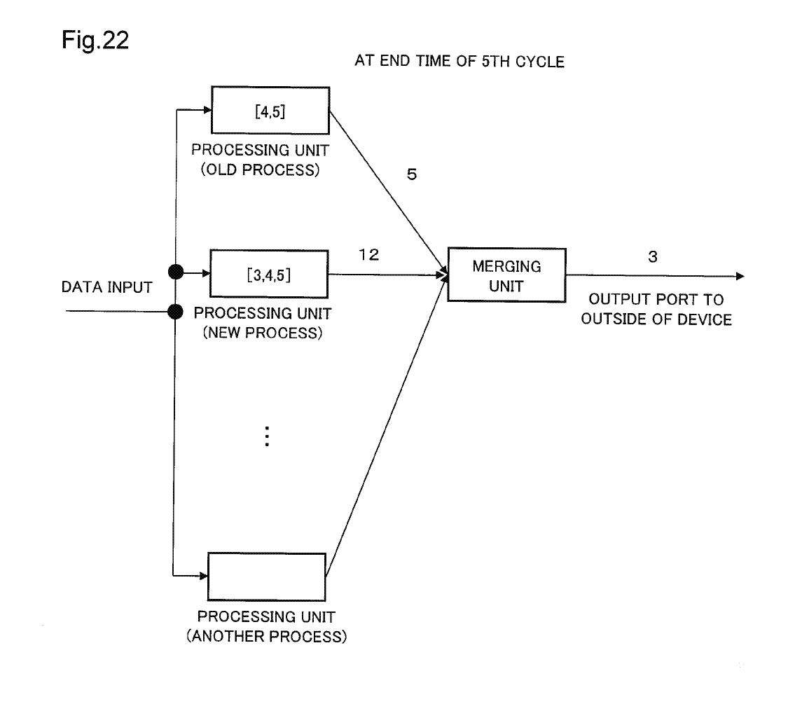

FIG. 23 a diagram showing a state of output data from respective units, at the end time of the sixth cycle, in the first way of the time-series data processing device of NPL 1.

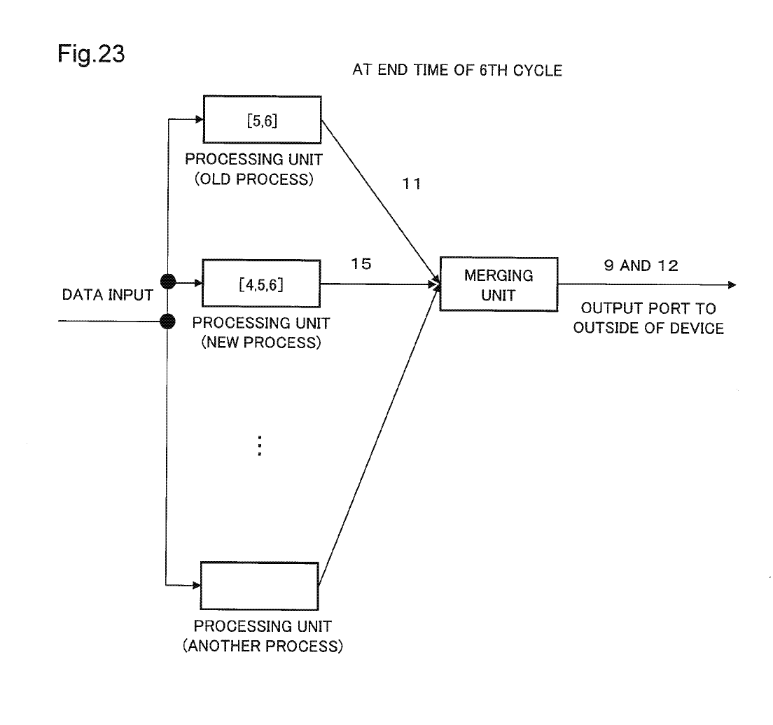

FIG. 24 a diagram showing a state of output data from respective units, at the end time of the second cycle, in a second way of the time-series data processing device of NPL 1.

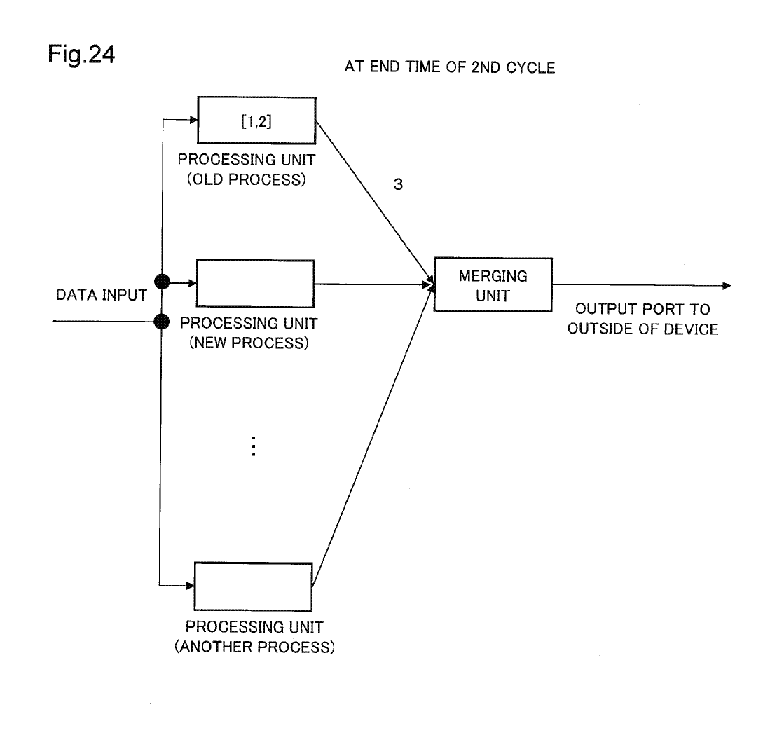

FIG. 25 a diagram showing a state of output data from respective units, at the end time of the third cycle, in the second way of the time-series data processing device of NPL 1.

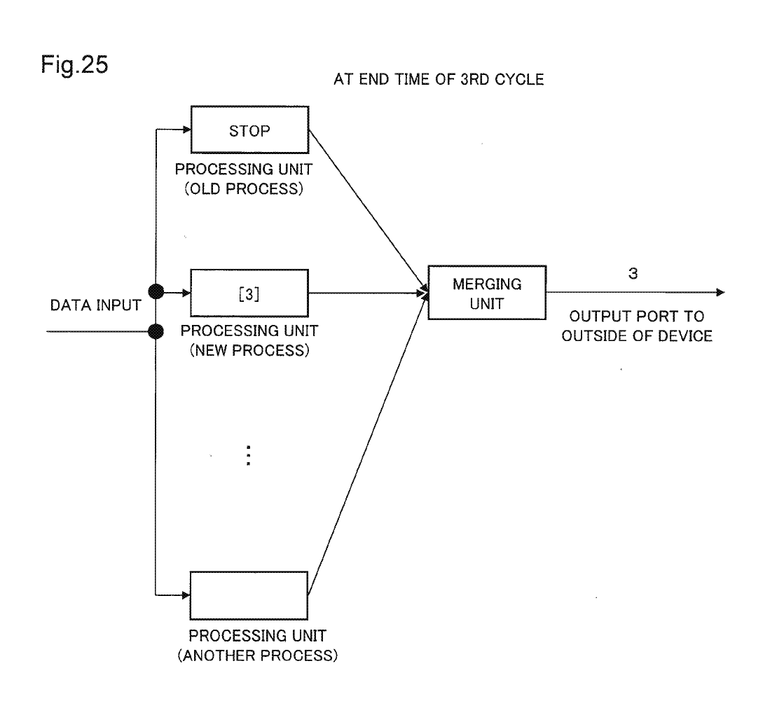

FIG. 26 a diagram showing a state of output data from respective units, at the end time of the fourth cycle, in the second way of the time-series data processing device of NPL 1.

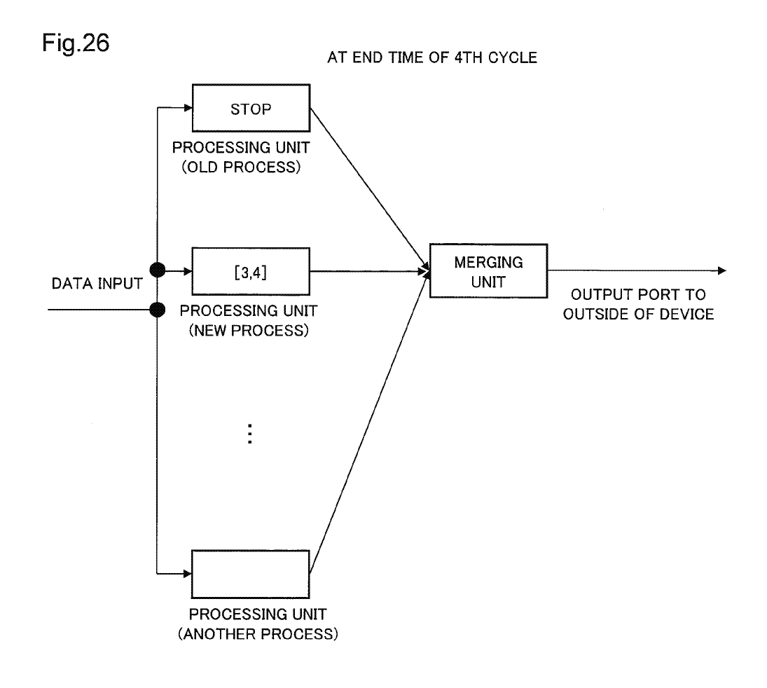

FIG. 27 a diagram showing a state of output data from respective units, at the end time of the fifth cycle, in the second way of the time-series data processing device of NPL 1.

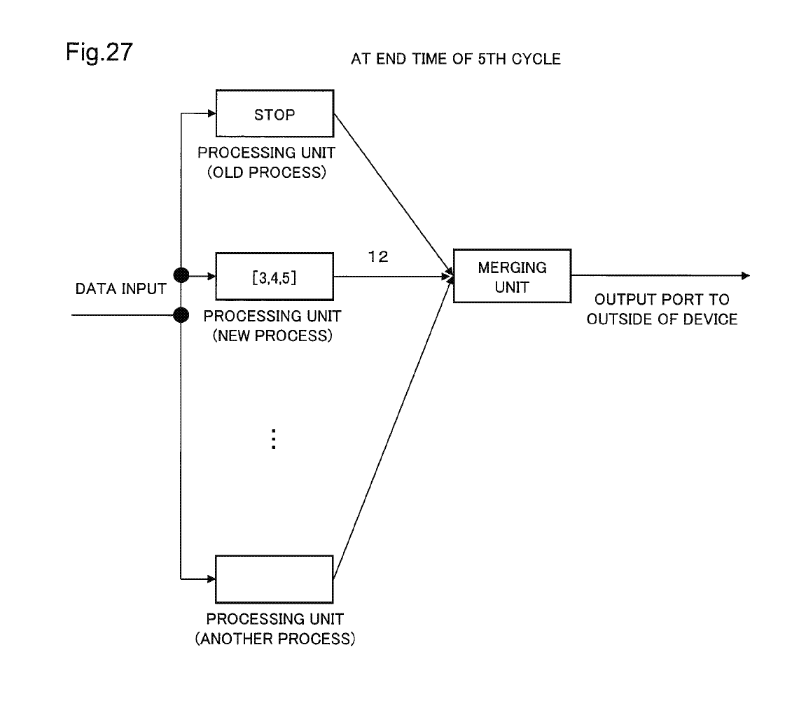

FIG. 28 a diagram showing a state of output data from respective units, at the end time of the sixth cycle, in the second way of the time-series data processing device of NPL 1.

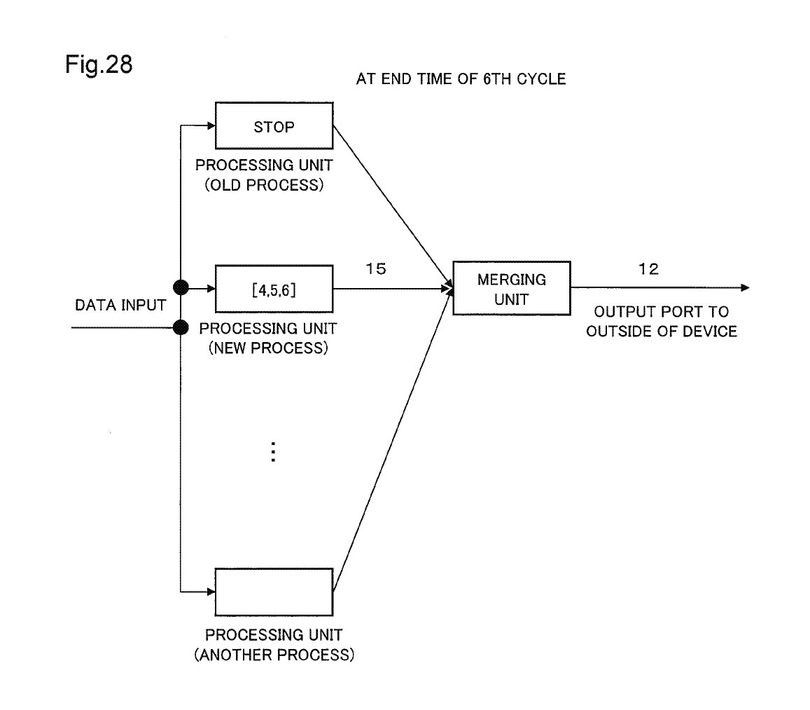

FIG. 29 a block diagram showing a configuration of a time-series data processing device configured by combining technologies of Patent Literature 2 to Patent Literature 4.

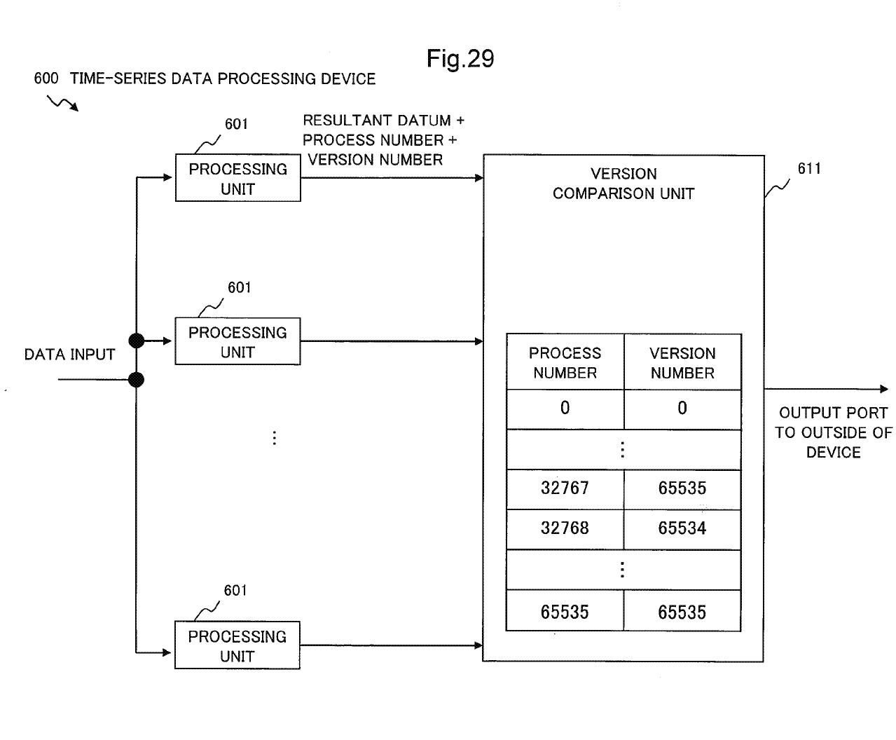

FIG. 30 a diagram showing a state of output data from respective units in the time-series data processing device of FIG. 29.

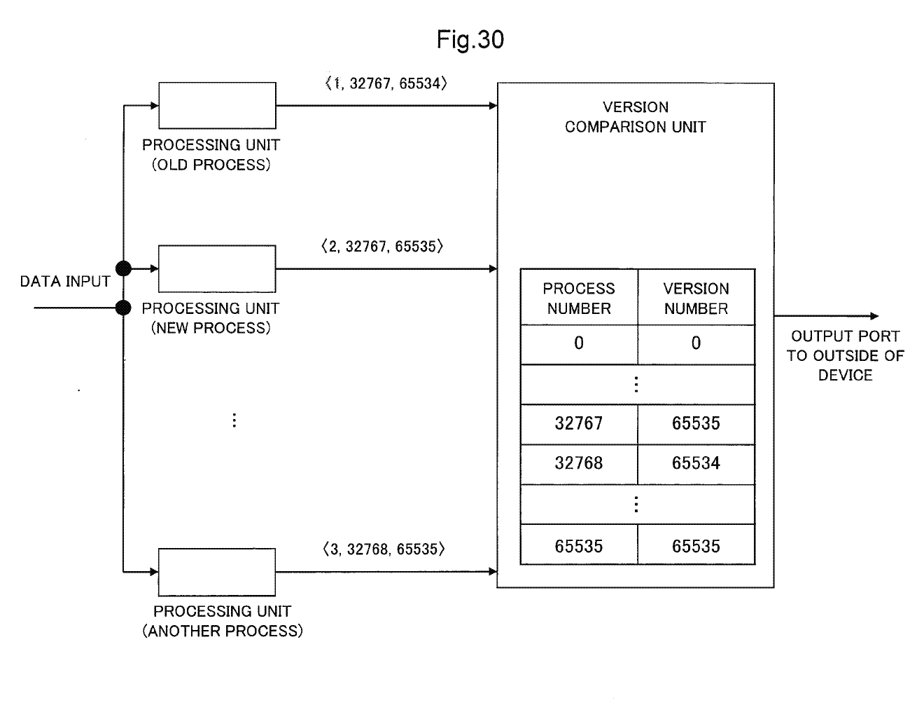

### DESCRIPTION OF EMBODIMENTS

### First Exemplary Embodiment

Next, an exemplary embodiment of the present invention will be described in detail, with reference to drawings.

In a time-series data processing device which performs processes on time-series data, user-defined processes are performed in a plurality of areas in an IC chip, and at run-time, the process of an optional one of the areas is switched into a process for performing a different operation. As already described above, the process before the switching is referred to as a “first user-defined process”, and the process after the switching as a “second user-defined process”. Alternatively, the process before the switching may be referred to as an “old process”, and the process after the switching as a “new process”.

In the present exemplary embodiment, process switching is realized in an IC chip, while reducing a time period in which no result is outputted, by writing circuit information for performing a new process into a circuit area different from that currently performing an old process, thus starting operation of the new process while keeping the old process in operation, and subsequently performing process switching in a manner of stopping the old process and then deleting circuit information for performing the old process. Here, the above-described process switching may be realized by the use of an IC chip having a plurality of areas into each of which circuit information for performing time-series data processing can be written (referred to as a “partition”). FPGA is mentioned as an example of such an IC chip.

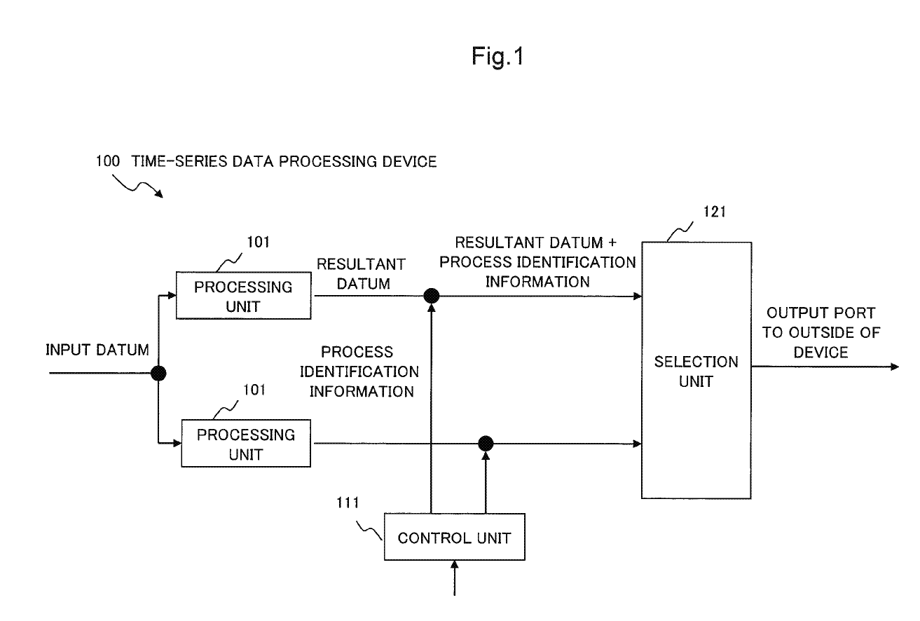

FIG. 1 is a block diagram showing a configuration of a time-series data processing device 100 according to the exemplary embodiment of the present invention.

The time-series data processing device 100 comprises processing units 101, a control unit 111 and a selection unit 121.

Some of the processing units 101 each perform an old process and accordingly output a resultant datum. Some of the processing units 101 each perform a new process having been substituted for an old process at run-time of the old process, and accordingly output a resultant datum. Whether the process performed by each of the processing units 101 is an old process or a new process is determined by the presence or absence of switching of the process performed by the processing unit 101. The function and internal configuration may be the same for all of the plurality of processing units 101, or may be different for some or all of them.

The control unit 111 sets “identification information” corresponding to the content of a process performed by each of the processing units 101. By difference in the identification information, difference in a process performed by each of the processing units 101 can be distinguished.

The purpose of setting the identification information will be described in detail below. In the time-series data processing device 100, it may occur that switching from an old process to a new process proceeds in a plurality of processing units simultaneously. That is, switching in a first processing unit from a first old process to a first new process and switching in a second processing unit from a second old process to a second new process may proceed simultaneously. In such a case, by using predetermined identification information, the first old process and the first new process can be distinguished from other processes, including the second old process and the second new process, operating simultaneously with the first old and new processes in the time-series data processing device 100.

The timing of instructions given from the outside for switching the process performed by the first processing unit and that of instructions for switching the process performed by the second processing unit are controlled to be different from each other. As a result of the control, it never occurs that switching from the first old process to the first new process and switching from the second old process to the second new process proceed simultaneously. Based on the control, states of the first old process and the first new process can be expressed by four kinds of identification information. The four kinds of identification information will be called “stable”, “transit-0”, “transit-1” and “transit-2”, respectively.

The “stable” means that the datum is a resultant datum of a case where process switching has not occurred, that is, a resultant datum by a process in a state where a pair of a new process and an old process has not been generated. Here, when process switching from an old process to a new process has been completed, identification information for a resultant datum becomes “stable” again, because the corresponding processing unit returns to the state where process switching has not occurred.

The “transit-0” means that process switching is proceeding, and also that a resultant datum corresponding to “transit-0” is a resultant datum obtained by a new process, among a pair of a resultant datum by the new process and that by an old process, which is ordered not to be outputted currently to the outside of the device.

The “transit-1” means that process switching is proceeding. Here, a resultant datum corresponding to “transit-1” is a resultant datum obtained by an old process, among a pair of a resultant datum by a new process and that by the old process, because it is obtained at an intermediate time point during process switching. When it is recorded in the selection unit 121, “transit-1” designates that a resultant datum to be outputted is that obtained by an old process.

The “transit-2” means that process switching is proceeding, and also that a resultant datum corresponding to “transit-2” is a resultant datum obtained by a new process, among a pair of the resultant datum by the new process and that by an old process, which is ordered to be outputted to the outside of the device. When it is recorded in the selection unit 121, “transit-2” designates that a resultant datum to be outputted is that obtained by a new process.

Then, at a time when the processing units 101 have outputted resultant data, the control unit 111 adds identification information to each of the resultant data and outputs the results to the selection unit 121. The identification information added to each of the resultant data can be any of the four kinds of identification information described above, and it accordingly is expressed in two bits. The 2-bit identification information can be realized by two wirings whose logic level is controlled by the control unit 111, or by two flip-flops whose hold value is controlled by the control unit 111.

As has been described above, in the present exemplary embodiment, during process switching from an old process to a new process, 2-bit identification information is added at the output of each of the processing units 101. Accordingly, when N-number of processes are simultaneously operated in the time-series data processing device 100, 2*N bits of information are totally added in the whole device.

In contrast, in the method obtained by combining PTL 2 to PTL 4, if assuming that the version number takes M-number of values and expressing a logarithm of N to the base 2 as log 2(N), (log 2(M)+log 2(N))*N bits of information are totally added to outputs from the processing units in the whole device.

Here, for example, assuming N and M both to be 65,536, the total number of bits for information to be added in the whole device is 131,072 and 2,097,152, respectively, in the present exemplary embodiment and in the method obtained by combining PTL 2 to PTL 4. Thus, the amount of information to be added is greatly reduced in the method of the present exemplary embodiment.

The selection unit 121 receives sets of a resultant datum and identification information correlated and added to it, from the plurality of processing units 101 and from the control unit 111. Identification information is registered in advance in the selection unit 121. The selection unit 121 performs operation switching by the use of the received identification information and the identification information registered in the selection unit 121. The operation switching is switching from operation of outputting a resultant datum obtained by an old process to the outside and discarding a resultant datum obtained by a new process, to operation of discarding a resultant datum by the old process and outputting a resultant datum by the new process to the outside. At a time of outputting a resultant datum, identification information added to the resultant datum to be outputted may also be outputted to the outside. After the process performed by a certain one of the processing units 101 is switched to a new process, the selection unit 121 records an event that a resultant datum by the new process has been outputted for the first time, using the identification information stored in the selection unit 121.

Here, the identification information stored and used in the selection unit 121 has only two variations, “transit-1” or “transit-2”, as will be described later; it accordingly can be expressed in one bit. The 1-bit identification information can be realized by one wiring whose logic level is controlled by the control unit 111, or by one flip-flop whose hold value is controlled by the control unit 111.

Accordingly, in the present exemplary embodiment, 1-bit identification information is stored in the selection unit 121. As a result, when N-number of processes are simultaneously operated in the time-series data processing device 100, 1-bit information is stored in the selection unit 121.

In contrast, in the method obtained by combining PTL 2 to PTL 4, if assuming that the version number takes M-number of values, log 2(M)*N bits of information are stored.

Here, for example, assuming N and M both to be 65,536, the total number of bits for information to be added in the whole device is 1 and 1,048,576, respectively, in the present exemplary embodiment and in the method obtained by combining PTL 2 to PTL 4. Thus, the amount of information to be added is greatly reduced in the method of the present exemplary embodiment.

In the present exemplary embodiment, for distinguishing between a result by an old process and a result by a new process, calculation is performed using identification information added to a resultant datum and identification information stored in the selection unit. When N-number of processes are simultaneously operated in parallel in the time-series data processing device 100, additional calculation using identification information is performed in the selection unit 121, for identification of the kind of a process, that is, identification of the processing unit 101 having performed the process. Thus, in the present exemplary embodiment, in the selection unit 121, a process with respect to the version number and that with respect to the process number are performed, that is, calculation using 2+1 bit input is performed.

In contrast, in the method obtained by combining PTL 2 to PTL 4, calculation using two version numbers is added. That is, if assuming that the version number takes M-number of values, calculation using 2*log 2(M) bit input is added.

Here, for example, assuming N and M both to be 65,536, the number of input bits necessary for the calculation is 3 and 32, respectively, in the present exemplary embodiment and in the method obtained by combining PTL 2 to PTL 4. Thus, in the present exemplary embodiment, the number of input bits for the calculation is greatly reduced, and accordingly, a time required for the calculation is greatly reduced.

In the method obtained by combining PTL 2 to PTL 4, for reducing the calculation time in the selection unit 121, an alternative way of increasing the hardware size, such as that of performing search and comparison processes in parallel, may be considered. In contrast, in the present exemplary embodiment, the hardware size can be greatly reduced even in such a case of performing parallel processing, because the number of input bits can be reduced.

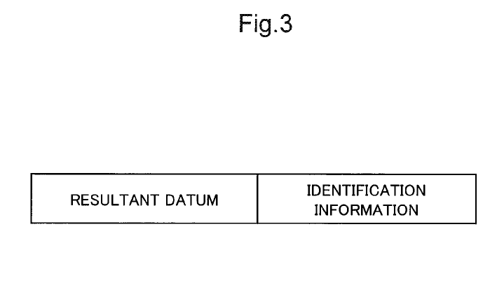

The control unit 111 outputs identification information in a manner to synchronize it with output of a resultant datum from each of the processing units 101. As a result, input information to the selection unit 121 is sets of a resultant datum outputted by the corresponding processing unit 101 and identification information added to the datum by the control unit. For example, each of the sets of information described above may have a configuration shown in FIG. 3. Hereafter, when each of the above-described sets of information each consisting of a resultant datum and corresponding identification information is treated as a single entity, it is referred to as a “resultant data set”.

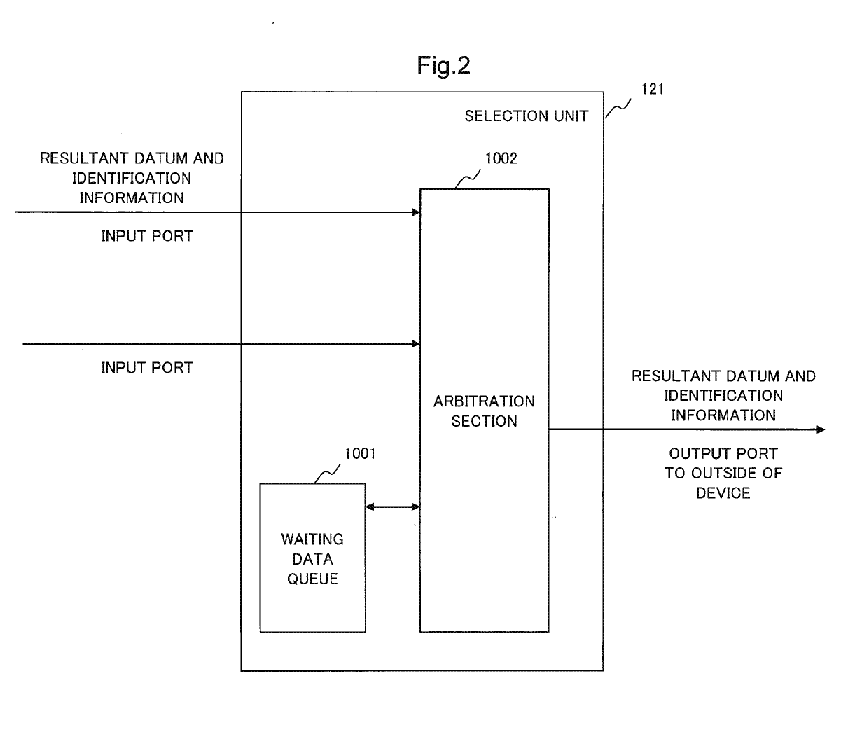

FIG. 2 is a block diagram showing an example of an internal configuration of the selection unit 121. The selection unit 121 comprises input ports, an output port, a waiting data queue 1001 and an arbitration section 1002. The selection unit 121 performs arbitration in output port assignment, by the use of the arbitration section 1002, among resultant data sets received from the two input ports and from the waiting data queue 1001. One of the resultant data sets to which the output port is assigned is outputted to the output port. The other ones of the resultant data sets to which the output port is not assigned are discarded or put into the waiting data queue 1001. The resultant data set put into the waiting data queue 1001 becomes an input to the selection unit 121 again in the next cycle.

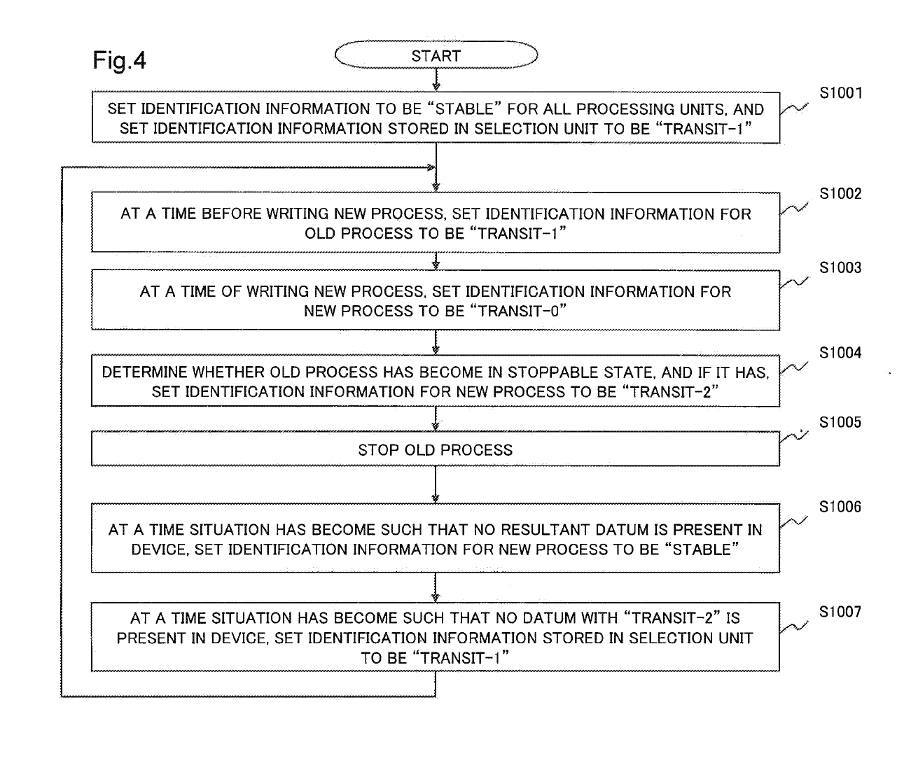

Next, a description will be given of operation of the time-series data processing device 100 according to the present exemplary embodiment, with reference to FIGS. 4, 5 and 6.

First, definition of some number of terms will be given. A time period since the arrival of a new input until the arrival of the next input is referred to as “one input period”. One clock period defining the unit of time necessary for the time-series data processing device to complete a predetermined operation is referred to as “one cycle”.

As already described above, a plurality of areas capable of being caused to perform a process are separately arranged in an IC chip, and each of them is referred to as a “partition”. In each partition, a circuit for performing a user-defined process can be created by setting there setting information referred to as configuration data.

“To order” and “to instruct” mean that a certain part (referred to as an “ordering part”) manipulates a signal of a wiring connected to another part (referred to as an “ordered part”), or writes a value into a storage device existing in the ordered part. “To register”, “to set” and “to record” mean that a part being the origin of registration writes a value into a storage device existing in another part being the destination of registration. “To transfer information”, “to transfer a datum” and “to output a result” mean that a part of the device being the origin of transfer manipulates a signal of a wiring connected to another part being the destination of transfer, or writes a value into a storage device existing in the part being the destination of transfer.

In the present exemplary embodiment, a resultant datum outputted from the time-series data processing device 100 is switched from that obtained by an old process to that by a new process. The switching is permitted by instructions to switch the process (hereafter, referred to as a “process switching instruction) made by a host computer or the like, which is not illustrated here, to the time-series data processing device 100. In the following description, it is assumed that the time-series data processing device 100 has already received the process switching instruction.

In the flow chart of FIG. 4, first, the control unit 111 sets identification information for all of the processing units 101 to be “stable” and sets identification information stored in the selection unit 121 to be “transit-1” (step S1001).

Next, at a time point before writing circuit information for performing a new process into an area other than an area into which circuit information for performing an old process has been written, in the corresponding processing unit 101, the control unit 111 sets identification information for the old process to be “transit-1” (step S1002).

Next, at a time point of writing the circuit information for performing the new process into the processing unit 101, the control unit 111 sets identification information for the new process to be “transit-0” (step S1003).

Next, the control unit 111 determines whether the old process has become in a state where it can be stopped, and if it has, sets the identification information for the new process to be “transit-2” (step S1004).

Here, the “state where the old process can be stopped” means a state where it is possible to stop operation of the processing unit 101 performing the old process and accordingly stop its outputting a resultant datum. In the state where the old process can be stopped, a resultant datum outputted from the time-series data processing device 100 can be switched from that by the old process to that by the new process.

That is, switching of a resultant datum outputted from the time-series data processing device 100 to that by the new process is not performed immediately after receiving the process switching instruction. Switching of a resultant datum outputted from the time-series data processing device 100 to that by the new process is performed after the old process becomes in the state where it can be stopped subsequently to reception of the process switching instruction by the time-series data processing device 100.

For example, the old process does not become in a stoppable state owing to a certain processing state of the processing unit 101 performing the old process, such as that where the old process is proceeding, or a certain outputting state of the processing unit 101, such as that where a series of data by the old process is still being outputted. In those cases, the time-series data processing device 100 continues to output a resultant datum obtained by the old process.

An entity instructing setting of identification information and providing a value may be a host computer which is not illustrated here. Alternatively, the entity may be the control unit 111.

Next, the control unit 111 stops the old process in the corresponding processing unit 101 (step S1005).

Next, at a time point when the state has become such that no resultant datum by the old process remains in the time-series data processing device 100, the control unit 111 sets the identification information for the new process to be “stable” (step S1006).

Next, at a time point when the state has become such that no datum of “transit-2” remains in the device, the control unit 111 sets the identification information stored in the selection unit 121 to be “transit-1”, and then returns to the step S1002 (step S1007).

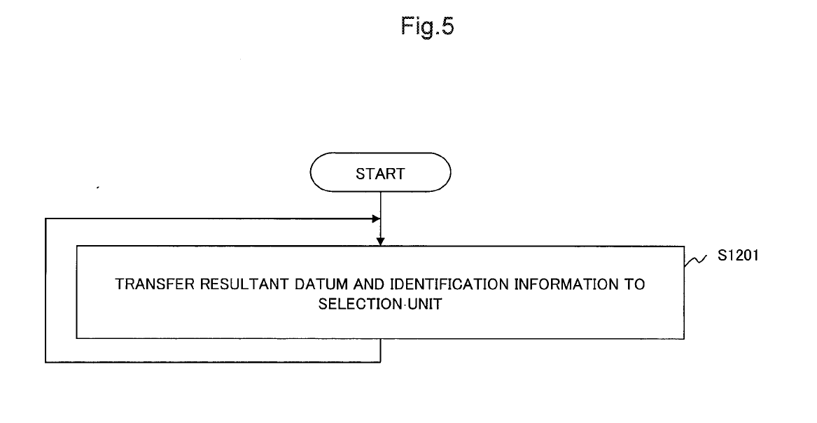

In parallel with the process of the operation illustrated by the flow chart of FIG. 4, a process illustrated by the flow chart of FIG. 5 is performed in the control unit 111. That is, the control unit 111 transfers a resultant data set to the selection unit 121 and then returns to the step S1201 (step S1201).

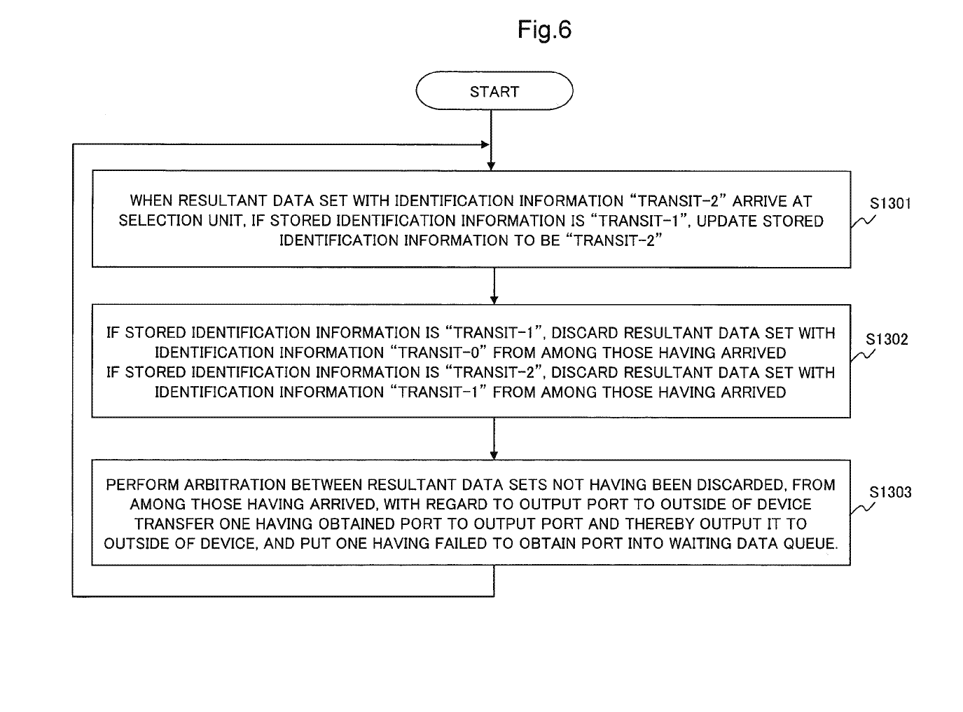

Also in parallel with the process of the operation illustrated by the flow chart of FIG. 4, a process illustrated by the flow chart of FIG. 6 is performed in the selection unit 121. That is, when a resultant data set whose identification information is “transit-2” has arrived and the stored identification information is “transit-1”, the selection unit 121 updates the stored identification information to be “transit-2” (step S1301).

Next, when the stored identification information is “transit-1”, the selection unit 121 discards a resultant data set whose identification information is “transit-0”, among resultant data sets having arrived. When the stored identification information is “transit-2”, the selection unit 121 discards a resultant data set whose identification information is “transit-1”, among those having arrived (step S1302).

Next, the selection unit 121 arbitrates in a right of using the output port to the outside of the device, between resultant data sets not having been discarded among those having arrived. Then, the selection unit 121 transfers one having obtained the right of using the output port to the output port and thereby outputs the one to the outside of the device, puts one having failed to obtain the right into the waiting data queue, and then returns to the step S1301 (step S1303).

The “waiting data queue” is a queue, in the selection unit 121, into which a resultant data set neither having been discarded nor having been outputted is put. The resultant data set having been stored into the waiting data queue is extracted from the waiting data queue in the next cycle, and is regarded as having arrived at the selection unit 121 at that time. The “arbitration in a right of using the output port” specifically means an action to select one resultant data set which is to be permitted to use the output port. When a resultant data set has been selected by the arbitration, the event is described as “the resultant data set obtained the port”.

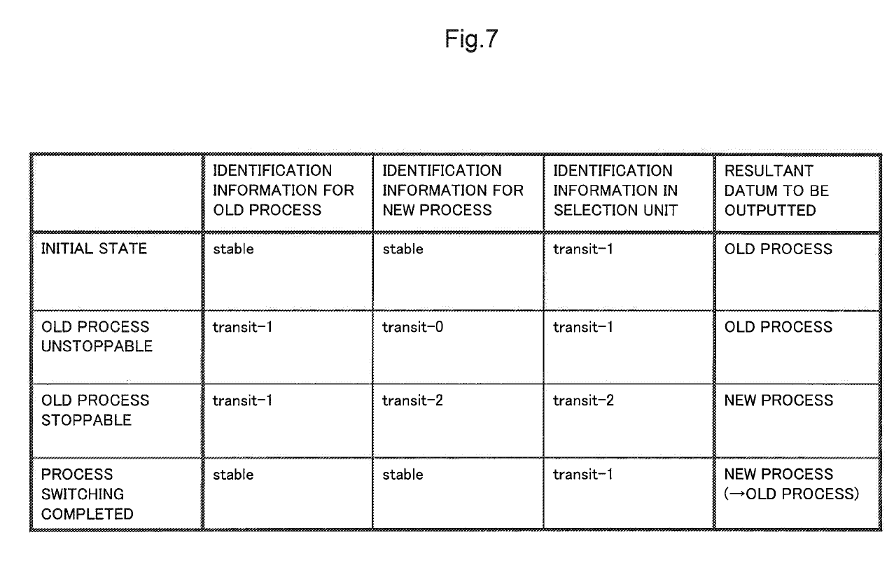

FIG. 7 shows identification information and a datum to be outputted in each state of the time-series data processing device 100.

In the initial state where process switching has not been performed, identification information is set to be “stable” for resultant data obtained by all processes, and identification information stored in the selection unit 121 is set to be “transit-1”. As a result of the above setting, resultant data obtained by all processes are outputted from the selection unit 121 to the outside of the device.

In the next state where process switching has been already started in the corresponding processing unit 101 but the old process has not become in a stoppable state, identification information for a resultant datum by the old process is changed to be “transit-1”. Further, identification information for a resultant datum by the new process is changed to be “transit-0”. However, the identification information stored in the selection unit 121 is not changed and accordingly kept being “transit-1”. As a result of the above setting, the selection unit 121 continues to discard a resultant datum obtained by the new process.

Then, when the old process has become in a stoppable state, identification information for a resultant datum by the new process is changed to be “transit-2”, and the identification information stored in the selection unit 121 is changed from “transit-1” to “transit-2”. As a result of the above setting, the selection unit 121 continues to discard a resultant datum obtained by the old process.

After the process switching has been completed, identification information for a resultant datum by the new process is changed to be “stable”, and the identification information stored in the selection unit 121 to be “transit-1”. As a result of the above setting, the state of each type of identification information returns to the initial state.

(Specific Example of Operation of Exemplary Embodiment)

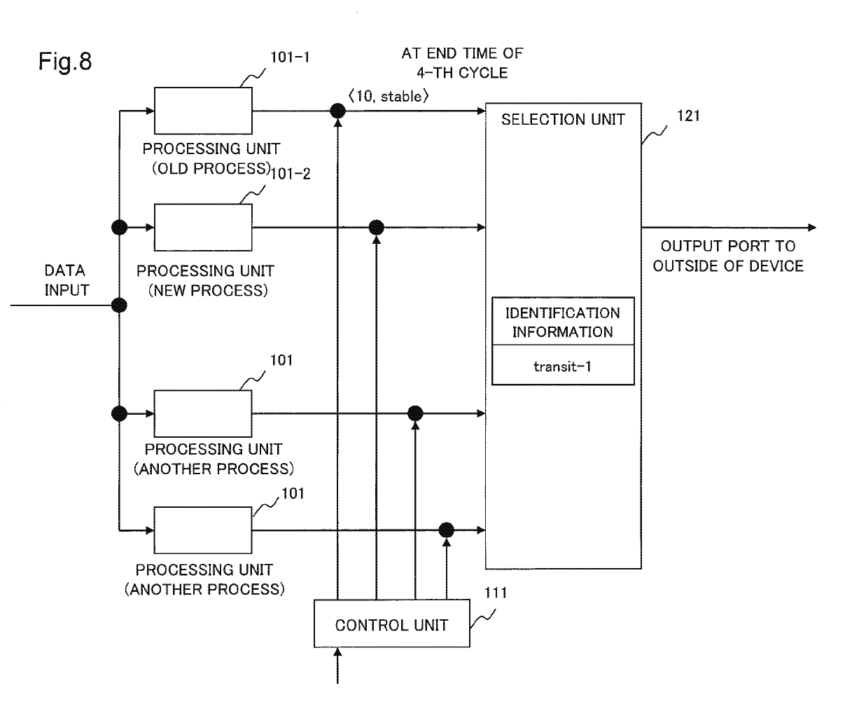

A description will be given below of a specific example of operation of the time-series data processing device 100 according to the present exemplary embodiment, with reference to the flow charts of FIGS. 4 to 6 and block diagrams shown in FIGS. 8 to 16.

The time-series data processing device 100 shown in FIGS. 8 to 16 comprises four processing units 101. Hereafter, a processing unit in charge of performing an old process is expressed as a processing unit 101-1, and a processing unit in charge of performing a new process as a processing unit 101-2. When describing a case which does not require distinguishing whether a process to be performed is the old one or the new one and accordingly applies to both of the processing units 101-1 and 101-2, or a case where a process other than the old and new processes is performed, expression as a processing unit 101 is made.

In the present specific example, it is considered that, with respect to time-series data on a stock's price, switching is made from a process of calculating the sum of four values (referred to as an “old process”) to a process of subtracting “2” from an input value (referred to as a “new process”).

In the following description, it is assumed that the old and new processes are each realized by writing circuit information for performing the process into a reconfigurable circuit element such as an FPGA and subsequently causing the circuit to operate. However, a way of realizing the old and new processes is not limited to such a way of realizing by hardware as described above. That is, as already described above, a way of realizing by software where a processor comprised in the processing unit 101 is caused to execute a program. In the way of realizing by software, it is only necessary to consider the following description by replacing “circuit information” described below by a “program”.

In the present specific example, a process is switched according to the following steps.

(1) write circuit information for performing a new process into an area other than an area in which circuit information for performing an old process has been written.

(2) start operation of the new process.

(3) start outputting by the new process.

(4) stop operation of the old process.

(5) delete the circuit information for performing the old process.

In the initial state, only the processing unit 101-1 performing the old process is in operation in the time-series data processing device 100.

Here, it is assumed that the old process has become able to be stopped, and the processing unit 101-1 informs the control unit 111 of a timing at which it is desired to stop outputting a resultant datum obtained by the old process and start outputting a resultant datum obtained by the new process. The timing is assumed to be a few cycles after completion of writing of circuit information for performing the new process into the processing unit 101-2 for the new process and subsequent start of the new process's outputting a result. That is, even in a few cycles after the new process has started outputting a result, results by the old process can be used. Accordingly, by making it possible to output such usable results obtained by the old process, the results can be used effectively.

The device for performing the old and new processes may be an FPGA. The destination to which the time-series data processing device 100 outputs a result may be a host computer. When the device for performing the old and new processes is an FPGA, the old process may be realized by writing required circuit information into the FPGA by the use of the reconfiguring function held by the FPGA.

Input data are each assumed to be an integer. As already described before, the period of a clock used for operation of the time-series data processing device is referred to as a “cycle”, which is used as the unit of time period. The “start time of a cycle” means the first time point of the time period, and the “end time of a cycle” does the last time point of the time period. For example, when the clock frequency is 1 GHz, with respect to a certain reference time, the first cycle means the time period from “the reference time plus zero second” to “the reference time plus 1 nanosecond”, and the N-th cycle means that from “the reference time plus (N−1) nanoseconds” to “the reference time plus N nanoseconds”. The start time of the M-th cycle means “the reference time plus (M−1) nanoseconds”, and the end time of the M-th cycle means “the reference time plus M nanoseconds”. It is assumed that an input datum is provided at the start time of each cycle.

“The processing unit 101 outputs a result” means that the processing unit 101 literally outputs a resultant datum it has calculated. The resultant datum calculated by the processing unit 101 is transferred, along with identification information added by the control unit 111, to the selection unit 121.

First, the control unit sets identification information for every processing unit to be “stable”, and identification information stored in the selection unit to be “transit-1” (step S1001).

Next, having received input data “1”, “2”, “3” and “4”, respectively, at the start times of the first, second, third and fourth cycles, the processing unit 101-1 performing the old process calculates and outputs the sum of the input data. The processing unit 101-1 outputs the resultant datum, and then the control unit 111 adds identification information “stable” to the resultant datum and transfers them together to the selection unit 121 (step S1201). The combination of a resultant datum and identification information is expressed as such as <10, stable>. Hereafter, such a set of values is referred to as a “result” or a “resultant data set”, as long as no confusion is raised. In FIG. 8, shown is output information inside the time-series data processing device 100 at that time point, that is, the resultant data transferred from the processing unit 101-1 to the selection unit 121.

At the start time of the fifth cycle, the resultant data set arrives at the selection unit 121. Because the identification information included in the resultant data set is not “transit-2”, the selection unit 121 does not update the identification information it stores (step S1301).

Because the stored identification information is “transit-1”, and the identification information included in the resultant data set having arrived is “stable”, the selection unit 121 does not discard the resultant datum (step S1302).

Because the only one resultant data set has arrived, and it has not been discarded, the selection unit 121 performs arbitration for the single resultant data set, with regard to the output port to the outside of the device. As the resultant data set obtains the output port as a result of the arbitration, the selection unit 121 transfers it to the output port to the outside of the device (step S1303).

The control unit 111 sets identification information for the old process to be <transit-1>, as preparation for writing of circuit information for performing the new process (step S1002). An input datum “5” is provided to the processing unit 101-1 performing the old process, and the control unit 111 consequently outputs <14, transit-1> to the selection unit 121.

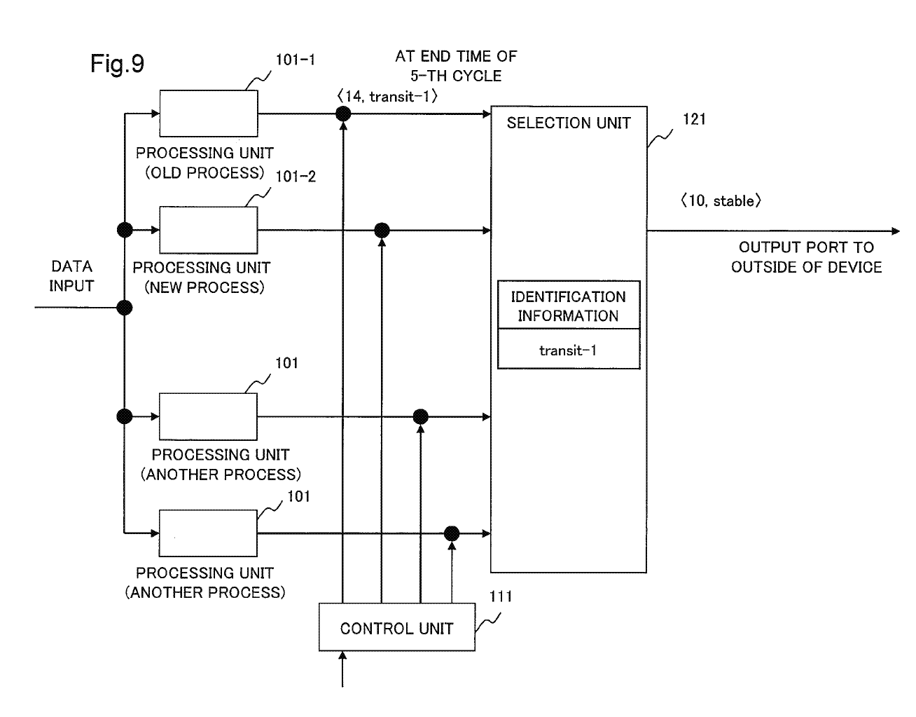

In FIG. 9, shown is output information inside the time-series data processing device 100 at the end time of the fifth cycle.

At the start time of the sixth cycle, the resultant data set obtained by the old process in the previous cycle arrives at the selection unit 121. Because the identification information included in the resultant data set is not “transit-2”, the selection unit 121 does not update the identification information it stores (step S1301).

Because the stored identification information is “transit-1”, and the identification information included in the resultant data set is “transit-1”, the selection unit 121 does not discard the resultant datum (step S1302).

The selection unit 121 performs arbitration for the resultant data set not having been discarded, with regard to the output port to the outside of the device. As the resultant data set obtains the output port as a result of the arbitration, the selection unit 121 transfers it to the output port to the outside of the device (step S1303).

It is assumed that, at that timing, circuit information for performing the new process is written into the processing unit 101-2, and the processing unit 101-2 starts performing the new process. The control unit 111 sets identification information for the new process to be “transit-0” (step S1003).

It is assumed that an input data “6” is then provided to the processing units 101-1 and 101-2. Accordingly, the processing unit 101-1 and the control unit 111 output a resultant data set <18, transit-1>, and the processing unit 101-2 and the control unit 111 output a resultant data set <4, transit-0>, both to the selection unit 121.

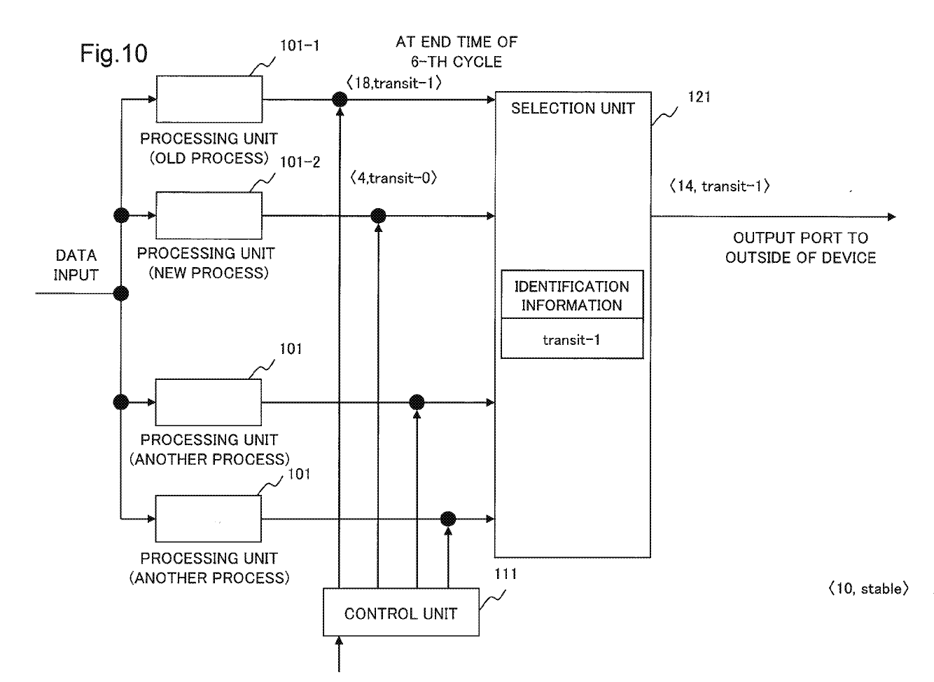

In FIG. 10, shown is output information inside the time-series data processing device 100 at the end time of the sixth cycle.

At the start time of the seventh cycle, the two resultant data sets obtained in the previous cycle respectively by the old process and the new process arrive at the selection unit 121. Because the identification information included in each of the two resultant data sets is not “transit-2”, the selection unit 121 does not update the identification information it stores (step S1301).

Because the stored identification information is “transit-1”, and the identification information included in the resultant data set obtained by the old process is “transit-1”, the selection unit 121 does not discard the resultant data set by the old process. On the other hand, because the identification information included in the resultant data set obtained by the new process is “transit-0”, the selection unit 121 discards it (step S1302).

Then, the selection unit 121 performs arbitration between the resultant data sets not having been discarded, with regard to the output port to the outside of the device. As the resultant data set by the old process obtains the output port as a result of the arbitration, the selection unit 121 transfers it to the output port to the outside of the device (step S1303). This operation makes it possible to avoid a problem in that a result by the old process and that by the new process are outputted to the outside of the device in a mixed manner. Further, because a useful resultant datum obtained by the old process is not discarded but is outputted to the outside of the device, the resultant datum can be used effectively.

It is assumed that, also in the present cycle, an input data “7” is provided to the processing units 101-1 and 101-2. Accordingly, the processing unit 101-1 and the control unit 111 output a resultant data set <22, transit-1>, and the processing unit 101-2 and the control unit 111 output a resultant data set <5, transit-0>, both to the selection unit 121.

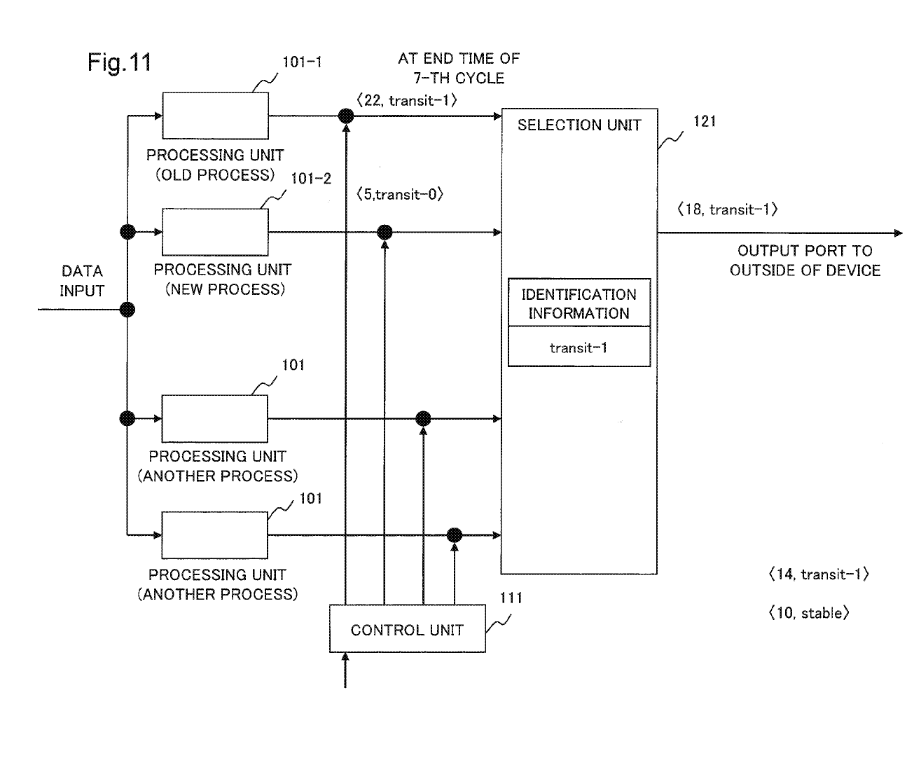

In FIG. 11, shown is output information inside the time-series data processing device 100 at the end time of the seventh cycle.

At the start time of the eighth cycle, the two resultant data sets obtained in the previous cycle respectively by the old process and the new process arrive at the selection unit 121. Because the identification information included in each of the two resultant data sets is not “transit-2”, the selection unit 121 does not update the identification information it stores (step S1301).

Because the stored identification information is “transit-1”, and the identification information included in the resultant data set obtained by the old process is “transit-1”, the selection unit 121 does not discard the resultant data set by the old process. On the other hand, because the identification information included in the resultant data set obtained by the new process is “transit-0”, the selection unit 121 discards it (step S1302).

Then, the selection unit 121 performs arbitration for the resultant data set not having been discarded, with regard to the output port to the outside of the device. As the resultant data set by the old process obtains the output port as a result of the arbitration, the selection unit 121 transfers it to the output port to the outside of the device (step S1303).

It is assumed that, in the present cycle, the old process has become in a stoppable state, and the control unit 111 accordingly has set identification information to be “transit-2” (step S1004). It is also assumed that, in the same cycle, the processing unit 101-1 and the control unit 111 output a resultant data set <26, transit-1>, and the processing unit 101-2 and the control unit 111 output a resultant data set <6, transit-2>, both to the selection unit 121.

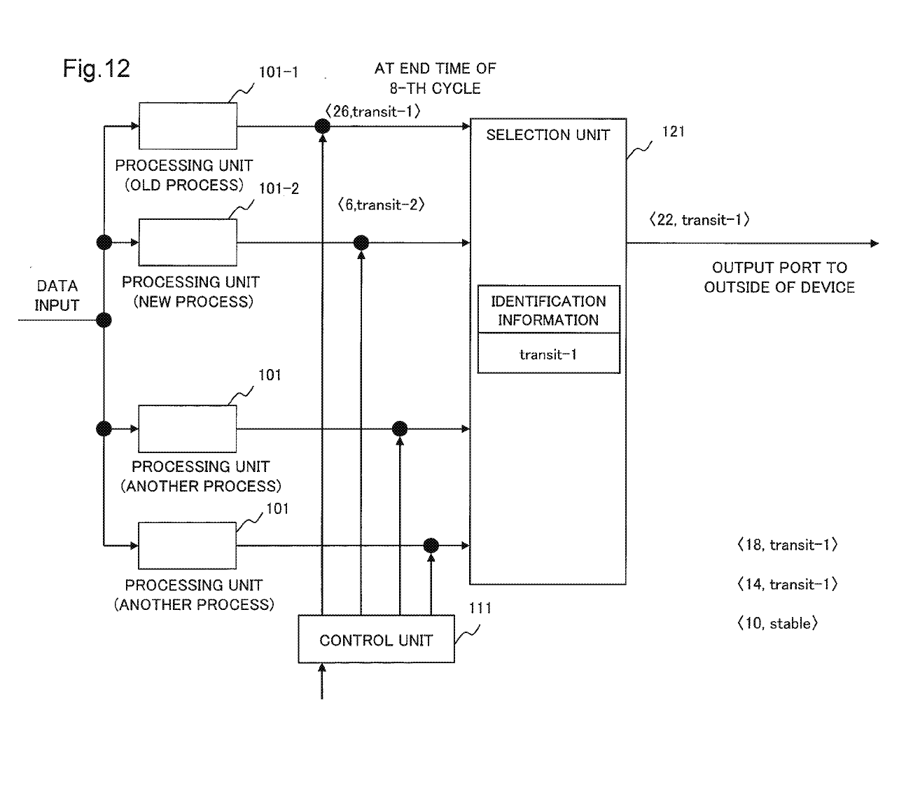

In FIG. 12, shown is output information inside the time-series data processing device 100 at the end time of the eighth cycle.

At the start time of the ninth cycle, the two resultant data sets obtained in the previous cycle respectively by the old process and the new process arrive at the selection unit 121. Because the stored identification information is “transit-1”, and the identification information included in the resultant data set obtained by the new process is “transit-2”, the selection unit 121 updates the stored identification information to be “transit-2” (step S1301).

Because the stored identification information is “transit-2”, and the identification information included in the resultant data set obtained by the new process is “transit-2”, the selection unit 121 does not discard the resultant data set by the new process (step S1302). On the other hand, because the identification information included in the resultant data set obtained by the old process is “transit-1”, the selection unit 121 discards it (step S1302).

Then, the selection unit 121 performs arbitration for the resultant data set not having been discarded, with regard to the output port to the outside of the device. As the resultant data set by the new process obtains the output port as a result of the arbitration, the selection unit 121 transfers it to the output port to the outside of the device (step S1303). This operation makes it possible to avoid a problem in that a result by the old process and that by the new process are outputted to the outside of the device in a mixed manner. The operation stops outputting a result obtained by the old process to the output port to the outside of the device, and starts alternatively outputting a result obtained by the new process. It is thus possible to smoothly switch a resultant datum outputted to the outside of the device from that obtained by the old process to that by the new process.

In the present cycle, the control unit 111 stops the old process performed by the processing unit 101-1 (step S1005).

It is assumed that, in the same cycle, the processing unit 101-2 and the control unit 111 outputs a resultant data set <7, transit-2>.

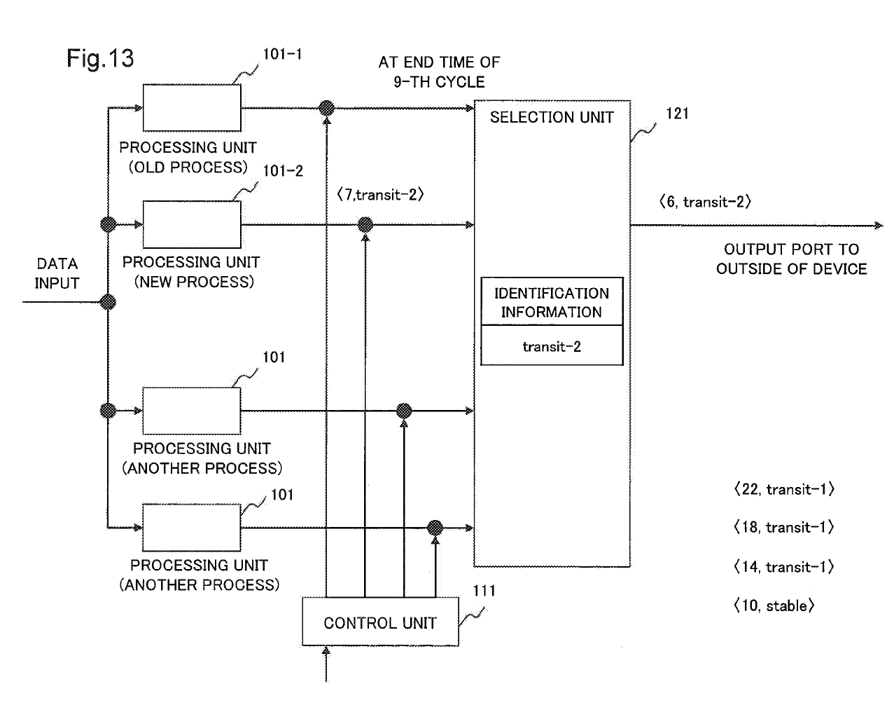

In FIG. 13, shown is output information inside the time-series data processing device 100 at the end time of the ninth cycle.

At the start time of the tenth cycle, the resultant data set obtained by the new process in the previous cycle arrives at the selection unit 121. Because the stored identification information is not “transit-1”, the selection unit 121 does not update the identification information it stores (step S1301). Because the recorded identification information is “transit-2”, and the identification information included in the resultant data set obtained by the new process is “transit-2”, the selection unit 121 does not discard the resultant data set by the new process (step S1302). Here, the selection unit 121 performs arbitration for the resultant data set not having been discarded, with regard to the output port to the outside of the device. As the resultant data set by the new process obtains the output port as a result of the arbitration, the selection unit 121 transfers it to the output port to the outside of the device (step S1303).

Because no resultant datum by the old process is present in the device, it is not necessary to distinguish between a resultant datum obtained by the old process and that by the new process and accordingly discard either one of them. Accordingly, in the present cycle, the control unit 111 sets identification information for the new process to be “stable” (step S1006).

It is assumed that, in the same cycle, the processing unit 101-2 and the control unit 111 outputs a resultant data set <8, stable>.

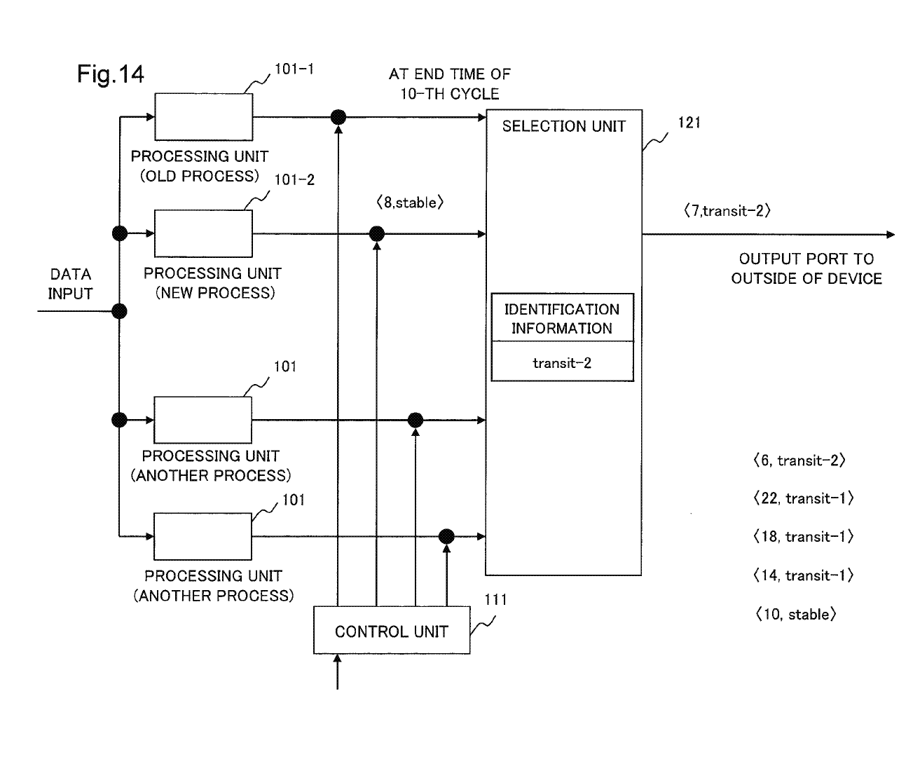

In FIG. 14, shown is output information inside the time-series data processing device 100 at the end time of the tenth cycle.

At the start time of the eleventh cycle, the resultant data set obtained by the new process in the previous cycle arrives at the selection unit 121. Because the stored identification information is not “transit-1”, the selection unit 121 does not update the identification information it stores (step S1301). Because the identification information included in the resultant data set obtained by the new process is “stable”, the selection unit 121 does not discard the resultant data set by the new process (step S1302). Here, the selection unit 121 performs arbitration for the resultant data set not having been discarded, with regard to the output port to the outside of the device. As the resultant data set by the new process obtains the output port as a result of the arbitration, the selection unit 121 transfers it to the output port to the outside of the device (step S1303).

It is assumed that, in the same cycle, the processing unit 101-2 and the control unit 111 outputs a resultant data set <9, stable>.

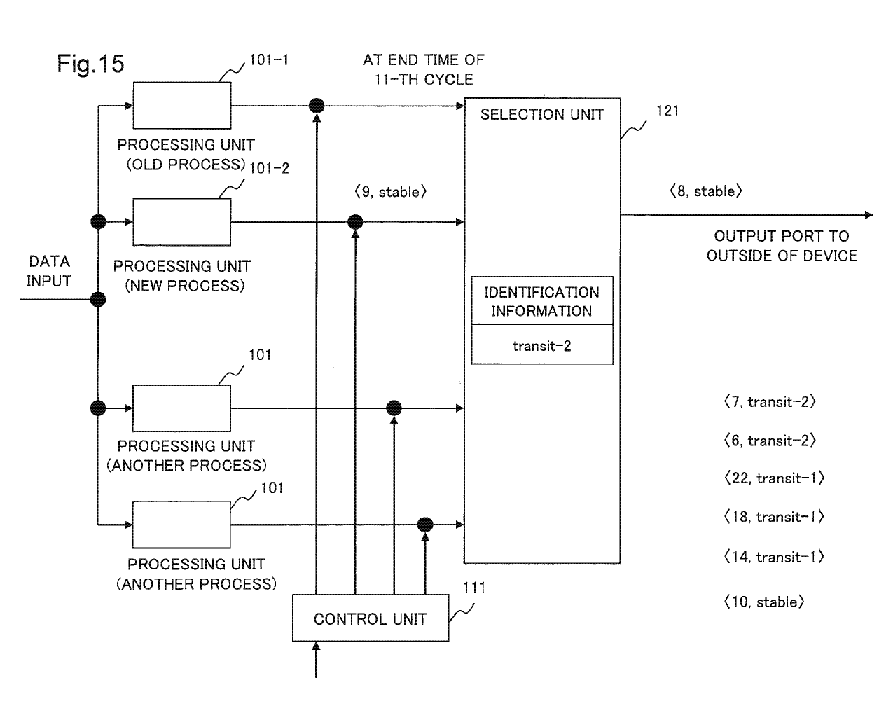

In FIG. 15, shown is output information inside the time-series data processing device 100 at the end time of the eleventh cycle.

At the start time of the twelfth cycle, similarly to in the previous cycle, the selection unit 121 transfers the resultant data set obtained by the new process in the previous cycle to the output port to the outside of the device.

Because no resultant datum accompanied by identification information “transit-2” is present in the device, the selection unit 121 does not need to discard any resultant data set. Accordingly, in the present cycle, the control unit 111 sets the identification information stored in the selection unit 121 to be “transit-1” (step S1007).

It is assumed that, in the same cycle, the processing unit 101-2 and the control unit 111 outputs a resultant data set <10, stable>.

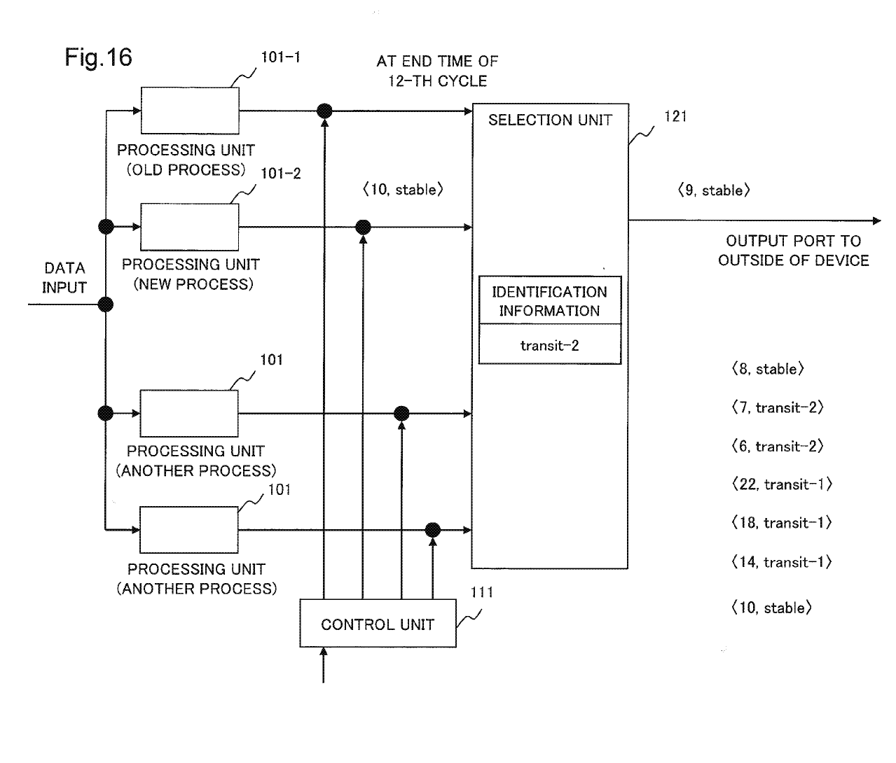

In FIG. 16, shown is output information inside the time-series data processing device 100 at the end time of the twelfth cycle.

In the subsequent cycles, the selection unit 121 continues outputting a resultant data set obtained by the new process to the output port to the outside of the device.

On the basis of the operation of the time-series data processing device 100 and resultant data outputted from it, which have been described above, the effect of the present exemplary embodiment will be described below.

The resultant datum sets outputted from the time-series data processing device 100 are lined up in order from the most recent to the most oldest as <10, stable> <14, transit-1> <18, transit-1> <22, transit-1> <6, transit-2> <7, transit-2> <8, stable>.

First, in the present exemplary embodiment, even after writing of circuit information for performing the new process into the processing unit 101-2, a useful and usable resultant datum obtained by the old process is not discarded but is outputted to the outside of the device, until the old process becomes in a stoppable state in the processing unit 101-1. In the case of the present exemplary embodiment, <18, transit-1> and <22, transit-1> correspond to such useful and usable resultant data obtained by the old process.

In contrast, for example, in the technology of NPL 1, the old process is stopped at the time of writing the new process, and accordingly, those useful and usable results are not outputted. Also in the technologies of PTL 1 to PTL 4, there is no consideration of outputting such useful and usable resultant data to be obtained by the old process.

As has been described above, according to the method of the present exemplary embodiment, useful and usable resultant data obtained by the old process, which are not outputted in the method of the background art technologies, are outputted to the utmost to the outside of the device.

Then, after a time when the old process has become in a stoppable state, resultant data by the old process are discarded, and alternatively, those outputted from the processing unit 101-2 performing the new process are outputted to the outside of the device. That is, at around a time of process switching, it never occurs that a result by the old process and that by the new process are both outputted in a mixed manner to the outside of the device.

Further, in contrast to the background art technologies, it becomes possible to reduce the amount of information added to resultant data, which is required for performing process switching from the old process to the new process at run-time, such that it requires only 2 bits for each of the processing units 101.

Also possible is reduction of the amount of calculation needed for selecting a resultant datum to be outputted from the time-series data device, when switching a process performed by the time-series data from the old process to the new process. That is, calculation using identification information included in a resultant data set and identification information stored in the selection unit 121, which is performed in the selection unit 121, can be reduced to be calculation using only 2-bit identification information and 1-bit identification information as input. If both kinds of identification information are used, as they are, in performing the calculation for distinguishing between the old and new processes, as done in the background art technologies, it is possible that the amount of calculation becomes huge, as already described before, Thus, in the present exemplary embodiment, the amount of calculation performed by the selection unit 121 can be reduced, and accordingly, the process delay time of the time-series data device can be reduced.

The time-series data processing device of the present exemplary embodiment can be realized by software. The flow charts of a program for controlling the time-series data processing device are the same as that shown in FIGS. 6 to 8. That is, the processes performed by the control unit 111 and the selection unit 121 may be realized by a processor comprised in the time-series data processing device executing the program.

The above-mentioned program may be stored in a non-temporary medium such as semiconductor memory devices, including a ROM (Read Only Memory), a RAM (Random Access Memory), a flash memory and the like, an optical disc, a magnetic disk and a magneto-optical disk.

The present invention has been described above with reference to the exemplary embodiment, but the present invention is not limited to the above-described exemplary embodiment. In the configurations and details of the present invention, various changes and modifications which are understandable to those skilled in the art can be made within the scope of the present invention.

This application is based upon and claims the benefit of priority from Japanese Patent Application No. 2012-204425, filed on Sep. 18, 2012, the disclosure of which is incorporated herein in its entirety by reference.

### INDUSTRIAL APPLICABILITY

As an example of application of the present invention, mentioned is a case where, in an application for calculating an average of values, a target time period for the average calculation is to be changed. For example, mentioned is an application for detecting an emergency including a fire by using, as input data, values of temperature sensors dispersively arranged over a wide area and taking their averages over a certain time period. In this example, applying the present invention, it becomes possible to realize a function of reducing the target time period for taking an average of the temperatures, in order to increase the speed of following temperature variation when temperature variation has become rapid.

As another example of application of the present invention, mentioned is an application in which a parameter or output information used for certain calculation is to be changed. For example, considered is an application for calculating an indicator for determining a timing of trading a financial product such as a stock. First, there are a plurality of necessary indicators, and a set of indicators to be outputted varies, depending on brands of financial products to be traded and trade strategies. One device can calculate only a finite number of indicators simultaneously. Brands to be traded and trade strategies vary with time. Therefore, applying the present invention, it becomes possible to realize a function of changing indicators to be calculated in accordance with brands to be traded and trade strategies at that time.

### REFERENCE SIGNS LIST

100 time-series data processing device
101, 101-1, 101-2 processing unit
111 control unit
121 selection unit
1001 waiting data queue
1002 arbitration unit
500 time-series data processing device
501 processing unit
511 merging unit
600 time-series data processing device
601 processing unit
611 version comparison unit

What is claimed is:

1. A time-series data processing device comprising:
a first processor for performing a first process and thereby outputting a first resultant datum;
a second processor for performing a second process and thereby outputting a second resultant datum;
a controller for, when having received instructions for process switching from the outside, determining whether said first process can be stopped or not, generating a first resultant data set by adding to said first resultant datum first identification information representing the state of said first process, and generating a second resultant data set by adding to said second resultant datum second identification information representing the state of said second process; and
a selecter for storing third identification information designating a resultant datum to be outputted to the outside, and for, when having received said first resultant data set or said second resultant data set, selecting either said first resultant data set or said second resultant data set to output the selected one and discard the other one, on the basis of a result of comparison between said first identification information and said third identification information and of a result of comparison between said second identification information and said third identification information.

2. The time-series data processing device according to claim 1, wherein
said controller determines whether said first process can be stopped or not, on the basis of a processing status of said first processor or of a status of outputting said first resultant datum by said first processor.

3. The time-series data processing device according to claim 1, wherein:
said first identification information represents the presence or absence of or the proceeding status of said process switching;
said second identification information represents whether said second resultant datum can be outputted to the outside or not, and also represents the presence or absence of or the proceeding status of said process switching; and
said third identification information designates which one of said first resultant datum and said second resultant datum is to be outputted.

4. The time-series data processing device according to claim 3, wherein,
when said second identification information indicates that said second resultant datum can be outputted to the outside, and said third identification information designates that said first resultant datum should be outputted, said selecter updates said third identification information in a manner to make it designate that said second resultant datum should be outputted.

5. The time-series data processing device according to claim 3, wherein
said selecter:
discards said second resultant datum when said third identification information designates that said first resultant datum should be outputted and said second identification information indicates that said second resultant datum cannot be outputted to the outside; and
discards said first resultant datum when said third identification information designates that said second resultant datum should be outputted and said first identification information indicates that said process switching is still under proceeding.

6. The time-series data processing device according to claim 3, wherein:
said controller:
adds said first identification information indicating that said process switching is under proceeding and said second identification information indicating that said second resultant datum cannot be outputted to the outside, before and until said first process becomes in a state where it can be stopped;
starts adding said second identification information indicating that said second resultant datum can be outputted to the outside, at a time when said first process has become in a state where it can be stopped; and
starts adding said second identification information indicating that said process switching has been completed, at a time when all of said first resultant data have been outputted to the outside or discarded, and
said selecter
stores said third identification information designating that said first resultant datum should be outputted, at a time when all of said second resultant data to which said second identification information indicating that said second resultant datum can be outputted to the outside have been outputted to the outside or discarded.

7. A time-series data processing method, comprising:
performing a first process and thereby outputting a first resultant datum, in a first processor;
performing a second process and thereby outputting a second resultant datum, in a second processor;
when having received instructions for process switching from the outside, determining whether said first process can be stopped or not;
generating a first resultant data set by adding to said first resultant datum first identification information representing the state of said first process;
generating a second resultant data set by adding to said second resultant datum second identification information representing the state of said second process;
storing third identification information designating a resultant datum to be outputted to the outside; and
when having received said first resultant data set or said second resultant data set, selecting either said first resultant data set or said second resultant data set to output the selected one and discard the other one, on the basis of a result of comparison between said first identification information and said third identification information and of a result of comparison between said second identification information and said third identification information.

8. A non-transitory recording medium for storing a time-series data processing program for causing a computer, which is comprised in a time-series data processing device comprising a first processor for performing a first process and thereby outputting a first resultant datum and a second processor for performing a second process and thereby outputting a second resultant datum, to function as:
a controller for, when having received instructions for process switching from the outside, determining whether said first process can be stopped or not, generating a first resultant data set by adding to said first resultant datum first identification information representing the state of said first process, and generating a second resultant data set by adding to said second resultant datum second identification information representing the state of said second process; and
a selecter for storing third identification information designating a resultant datum to be outputted to the outside, and for, when having received said first resultant data set or said second resultant data set, selecting either said first resultant data set or said second resultant data set to output the selected one and discard the other one, on the basis of a result of comparison between said first identification information and said third identification information and of a result of comparison between said second identification information and said third identification information.
